(19) United States
(12) Patent Application Publication
(10) Pub. No.: US 2025/0317802 A1
(43) Pub. Date: Oct. 9, 2025

(54) CONFIGURATION OF A TYPE OF RADIO FREQUENCY (RF) THRESHOLDS

(71) Applicant: QUALCOMM Incorporated, San Diego, CA (US)

(72) Inventors: Akash KUMAR, Hyderabad (IN); Eswar Venkata Narasimha Muthyala Prasad BAHADURSHA, Hyderabad (IN)

(21) Appl. No.: 18/629,765

(22) Filed: Apr. 8, 2024

(51) Int. Cl. H04W 28/18; H04W 28/02; H04W 28/08

(52) U.S. Cl. CPC H04W 28/18; H04W 28/0236; H04W 28/08

(57) ABSTRACT

Methods, systems, and devices for wireless communications are described. In some wireless communications systems, a user equipment (UE) may support multiple different types of radio frequency (RF) thresholds, where a type of RF thresholds includes at least an in-band performance threshold and an out-of-band performance threshold. A network entity may determine a type of RF thresholds for the UE based on the UE's location within a cell of the network entity, cell load information for the cell, distributions of UEs or scheduled communications within the cell, or some combination of these or other parameters. The network entity may dynamically or semi-statically configure the UE with the type of RF thresholds. The UE may select an RF configuration based on the configured type of RF thresholds and may communicate using the RF configuration. The communications may satisfy the in-band and out-of-band performance thresholds based on the UE's RF configuration.

### FIELD OF TECHNOLOGY

The following relates to wireless communications, including the configuration of a type of radio frequency (RF) thresholds.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE communicating via a frequency band in a wireless communications system may operate according to a set of radio frequency (RF) thresholds. The set of RF thresholds may include one or more in-band performance thresholds for the frequency band and one or more out-of-band performance thresholds for frequency resources external to the frequency band (e.g., for frequency regions bordering the frequency band). To satisfy the set of RF thresholds, the UE may adjust RF configuration parameters, such as reducing a transmit power, setting a power amplifier (PA) bias value, setting a PA current value, or some combination thereof for communications. These adjustments to the RF configuration parameters may potentially reduce network coverage near a cell edge, degrade uplink throughput, increase power overhead associated with communications, or any combination thereof based on the set of RF thresholds.

### SUMMARY

The described techniques relate to improved methods, systems, devices, and apparatuses that support configuration of a type of radio frequency (RF) thresholds for a user equipment (UE). For example, the described techniques provide for improved coverage, capacity, and power consumption associated with RF configurations of the UE. In some wireless communications systems, a UE may support multiple different types of RF thresholds, where a type of RF thresholds includes at least an in-band performance threshold and an out-of-band performance threshold for wireless communications. In some examples, the UE may transmit a message including capability information for the UE, where the capability information may indicate the types of RF thresholds supported by the UE, a mechanism for switching (e.g., dynamically, semi-statically, or both) between types of RF thresholds supported by the UE, or both. A network entity may determine a type of RF thresholds for the UE based on the UE's location within a cell of the network entity, cell load information for the cell, distributions of UEs or scheduled communications within the cell, priorities of communications, or any combination of these or other parameters. The network entity may dynamically or semi-statically configure the UE with the type of RF thresholds. The UE may select an RF configuration based on the configured type of RF thresholds and may communicate using the RF configuration. The communications may satisfy the in-band and out-of-band performance thresholds based on the UE's RF configuration for the corresponding type of RF thresholds. Additionally, or alternatively, the network entity may coordinate configurations and scheduling across UEs, cells, or both to mitigate the effects of the UE communications on other wireless devices (e.g., other UEs, network entities, or both).

A method for wireless communications at a UE is described. The method may include receiving a first message that configures the UE with a first type of RF thresholds from a set of multiple types of RF thresholds supported by the UE, the first type of RF thresholds including at least an in-band performance threshold and an out-of-band performance threshold, and transmitting a second message that satisfies the in-band performance threshold and the out-of-band performance threshold based on an RF configuration for the UE corresponding to the first type of RF thresholds.

A UE for wireless communications is described. The UE may include one or more memories storing processor-executable code, and one or more processors coupled with the one or more memories. The one or more processors may individually or collectively be operable to execute the code to cause the UE to receive a first message that configures the UE with a first type of RF thresholds from a set of multiple types of RF thresholds supported by the UE, the first type of RF thresholds including at least an in-band performance threshold and an out-of-band performance threshold, and transmit a second message that satisfies the in-band performance threshold and the out-of-band performance threshold based on an RF configuration for the UE corresponding to the first type of RF thresholds.

Another UE for wireless communications is described. The UE may include means for receiving a first message that configures the UE with a first type of RF thresholds from a set of multiple types of RF thresholds supported by the UE, the first type of RF thresholds including at least an in-band performance threshold and an out-of-band performance threshold, and means for transmitting a second message that satisfies the in-band performance threshold and the out-of-band performance threshold based on an RF configuration for the UE corresponding to the first type of RF thresholds.

A non-transitory computer-readable medium storing code for wireless communications is described. The code may include instructions executable by one or more processors to receive a first message that configures the UE with a first type of RF thresholds from a set of multiple types of RF thresholds supported by the UE, the first type of RF thresholds including at least an in-band performance threshold and an out-of-band performance threshold, and transmit a second message that satisfies the in-band performance threshold and the out-of-band performance threshold based on an RF configuration for the UE corresponding to the first type of RF thresholds.

Some examples of the method, UEs, and non-transitory computer-readable medium described herein may further include operations, features, means, or instructions for selecting the RF configuration for the UE based on the first message.

In some examples of the method, UEs, and non-transitory computer-readable medium described herein, selecting the RF configuration for the UE may include operations, features, means, or instructions for setting a power amplifier (PA) bias value, a PA current value, a threshold transmit power level, or a combination thereof for the UE, where the second message may be transmitted according to the PA bias value, the PA current value, the threshold transmit power level, or the combination thereof.

Some examples of the method, UEs, and non-transitory computer-readable medium described herein may further include operations, features, means, or instructions for transmitting a third message reporting the set of multiple types of RF thresholds supported by the UE, where the first message that configures the UE may be in accordance with the third message.

Some examples of the method, UEs, and non-transitory computer-readable medium described herein may further include operations, features, means, or instructions for transmitting a fourth message reporting a capability of the UE to dynamically switch between the set of multiple types of RF thresholds supported by the UE, where the first message may be received based on the capability of the UE.

Some examples of the method, UEs, and non-transitory computer-readable medium described herein may further include operations, features, means, or instructions for transmitting a fifth message requesting to switch to the first type of RF thresholds based on a current battery power of the UE, an active radio configuration for the UE, or both, where the first message may be received based on the fifth message.

In some examples of the method, UEs, and non-transitory computer-readable medium described herein, the fifth message includes a UE assistance information (UAI) message.

In some examples of the method, UEs, and non-transitory computer-readable medium described herein, the first message includes a first radio resource control (RRC) message, a first medium access control (MAC) control element (MAC-CE), or a first combination thereof. Some examples of the method, UEs, and non-transitory computer-readable medium described herein may further include operations, features, means, or instructions for switching to the RF configuration for the UE based on the first RRC message, the first MAC-CE, or the first combination thereof, receiving a second RRC message, a second MAC-CE, or a second combination thereof that configures the UE with a second type of RF thresholds from the set of multiple types of RF thresholds supported by the UE, and switching to a second RF configuration for the UE corresponding to the second type of RF thresholds based on the second RRC message, the second MAC-CE, or the second combination thereof.

In some examples of the method, UEs, and non-transitory computer-readable medium described herein, the first message includes a downlink control information (DCI) message. Some examples of the method, UEs, and non-transitory computer-readable medium described herein may further include operations, features, means, or instructions for switching from a first RF configuration for the UE to the RF configuration for the UE for a transmission opportunity (TXOP) associated with the second message based on the DCI message indicating the TXOP and switching back to the first RF configuration for the UE for a subsequent TXOP.

Some examples of the method, UEs, and non-transitory computer-readable medium described herein may further include operations, features, means, or instructions for communicating in accordance with a default type of RF thresholds prior to receiving the first message that configures the UE with the first type of RF thresholds.

Some examples of the method, UEs, and non-transitory computer-readable medium described herein may further include operations, features, means, or instructions for storing a lookup table that maps one or more types of RF thresholds from the set of multiple types of RF thresholds supported by the UE to one or more respective RF configurations for the UE and determining the RF configuration for the UE corresponding to the first type of RF thresholds based on the lookup table.

Some examples of the method, UEs, and non-transitory computer-readable medium described herein may further include operations, features, means, or instructions for communicating one or more uplink messages, one or more sidelink messages, one or more downlink messages, or any combination thereof based on the RF configuration for the UE.

In some examples of the method, UEs, and non-transitory computer-readable medium described herein, the first type of RF thresholds indicates a signal quality for transmission at the UE and the second message may be transmitted based on the signal quality for transmission.

A method for wireless communications at a network entity is described. The method may include transmitting, for a UE, a first message that configures the UE with a first type of RF thresholds from a set of multiple types of RF thresholds supported by the UE, the first type of RF thresholds including at least an in-band performance threshold and an out-of-band performance threshold, and receiving a second message that satisfies the in-band performance threshold and the out-of-band performance threshold based on an RF configuration for the UE corresponding to the first type of RF thresholds.

A network entity for wireless communications is described. The network entity may include one or more memories storing processor-executable code, and one or more processors coupled with the one or more memories. The one or more processors may individually or collectively be operable to execute the code to cause the network entity to transmit, for a UE, a first message that configures the UE with a first type of RF thresholds from a set of multiple types of RF thresholds supported by the UE, the first type of RF thresholds including at least an in-band performance threshold and an out-of-band performance threshold, and receive a second message that satisfies the in-band performance threshold and the out-of-band performance threshold based on an RF configuration for the UE corresponding to the first type of RF thresholds.

Another network entity for wireless communications is described. The network entity may include means for transmitting, for a UE, a first message that configures the UE with a first type of RF thresholds from a set of multiple types of RF thresholds supported by the UE, the first type of RF thresholds including at least an in-band performance threshold and an out-of-band performance threshold, and means for receiving a second message that satisfies the in-band performance threshold and the out-of-band performance threshold based on an RF configuration for the UE corresponding to the first type of RF thresholds.

A non-transitory computer-readable medium storing code for wireless communications is described. The code may include instructions executable by one or more processors to transmit, for a UE, a first message that configures the UE with a first type of RF thresholds from a set of multiple types of RF thresholds supported by the UE, the first type of RF thresholds including at least an in-band performance threshold and an out-of-band performance threshold, and receive a second message that satisfies the in-band performance threshold and the out-of-band performance threshold based on an RF configuration for the UE corresponding to the first type of RF thresholds.

Some examples of the method, network entities, and non-transitory computer-readable medium described herein may further include operations, features, means, or instructions for determining the first type of RF thresholds for the UE based on a distribution of UEs within a cell associated with the network entity, a location of the UE within the cell, a cell load for the cell, a scheduling distribution for communications associated with the UEs within the cell, an application type for the UE, a power threshold associated with the UE, a subscription plan associated with the UE, or any combination thereof.

Some examples of the method, network entities, and non-transitory computer-readable medium described herein may further include operations, features, means, or instructions for receiving a third message reporting the set of multiple types of RF thresholds supported by the UE, where the RF configuration for the UE may be in accordance with the third message.

Some examples of the method, network entities, and non-transitory computer-readable medium described herein may further include operations, features, means, or instructions for receiving a fourth message reporting a capability of the UE to dynamically switch between the set of multiple types of RF thresholds supported by the UE, where the first message may be transmitted based on the capability of the UE.

Some examples of the method, network entities, and non-transitory computer-readable medium described herein may further include operations, features, means, or instructions for receiving a fifth message requesting for the UE to switch to the first type of RF thresholds, where the first message may be transmitted based on the fifth message.

Some examples of the method, network entities, and non-transitory computer-readable medium described herein may further include operations, features, means, or instructions for transmitting, for a second UE different from the UE, a sixth message scheduling one or more communications for the second UE based on the RF configuration for the UE.

Some examples of the method, network entities, and non-transitory computer-readable medium described herein may further include operations, features, means, or instructions for determining a first bandwidth part (BWP) associated with the RF configuration for the UE and scheduling the one or more communications for the second UE for a second BWP different from the first BWP based on the RF configuration for the UE.

Some examples of the method, network entities, and non-transitory computer-readable medium described herein may further include operations, features, means, or instructions for predicting interference associated with the second message based on the first type of RF thresholds configured for the UE and scheduling the one or more communications for the second UE based on the predicted interference.

Some examples of the method, network entities, and non-transitory computer-readable medium described herein may further include operations, features, means, or instructions for transmitting, for a second UE different from the UE, a seventh message that configures the second UE with a second type of RF thresholds from a second set of multiple types of RF thresholds supported by the second UE based on the first type of RF thresholds configured for the UE.

Some examples of the method, network entities, and non-transitory computer-readable medium described herein may further include operations, features, means, or instructions for transmitting, for a second UE different from the UE, an eight message that configures the second UE with a modulation and coding scheme (MCS) value based on a predicted impact of the first type of RF thresholds configured for the UE on the second UE.

In some examples of the method, network entities, and non-transitory computer-readable medium described herein, the first message includes an RRC message, a MAC-CE, a DCI message, or any combination thereof.

Some examples of the method, network entities, and non-transitory computer-readable medium described herein may further include operations, features, means, or instructions for communicating one or more uplink messages, one or more downlink messages, or any combination thereof based on the RF configuration for the UE.

### BRIEF DESCRIPTION OF THE DRAWINGS

FIG. 1 shows an example of a wireless communications system that supports configuration of a type of radio frequency (RF) thresholds in accordance with one or more aspects of the present disclosure.

FIG. 2 shows an example of a network architecture that supports configuration of a type of RF thresholds in accordance with one or more aspects of the present disclosure.

FIG. 3 shows an example of a wireless communications system that supports configuration of a type of RF thresholds in accordance with one or more aspects of the present disclosure.

FIG. 4 shows an example of a process flow that supports configuration of a type of RF thresholds in accordance with one or more aspects of the present disclosure.

FIGS. 5 and 6 show block diagrams of devices that support configuration of a type of RF thresholds in accordance with one or more aspects of the present disclosure.

FIG. 7 shows a block diagram of a communications manager that supports configuration of a type of RF thresholds in accordance with one or more aspects of the present disclosure.

FIG. 8 shows a diagram of a system including a device that supports configuration of a type of RF thresholds in accordance with one or more aspects of the present disclosure.

FIGS. 9 and 10 show block diagrams of devices that support configuration of a type of RF thresholds in accordance with one or more aspects of the present disclosure.

FIG. 11 shows a block diagram of a communications manager that supports configuration of a type of RF thresholds in accordance with one or more aspects of the present disclosure.

FIG. 12 shows a diagram of a system including a device that supports configuration of a type of RF thresholds in accordance with one or more aspects of the present disclosure.

FIGS. 13 through 16 show flowcharts illustrating methods that support configuration of a type of RF thresholds in accordance with one or more aspects of the present disclosure.

### DETAILED DESCRIPTION

Wireless communications systems may define radio frequency (RF) thresholds for communications. For example, for a user equipment (UE) communicating via an operating frequency band, the RF thresholds may define one or more in-band thresholds for within the operating frequency band and one or more out-of-band thresholds for outside the operating frequency band (e.g., due to signal emissions). However, systems that use static (e.g., configured, pre-defined, standardized) RF thresholds for a specific radio access technology (RAT), frequency band, and bandwidth configuration may reduce flexibility of UE operations. For example, such RF thresholds may reduce network cell coverage (e.g., especially near the cell edge), increase power consumption, and degrade UE performance in some configurations.

To improve UE performance, power consumption, and network cell coverage, a wireless communications system may support multiple different configurations (e.g., “Types”) of RF thresholds. For example, the wireless communications system may support different combinations of RF thresholds corresponding to different types for a same RAT, frequency band, and bandwidth configuration. The wireless network may trigger UEs to switch between different types of RF thresholds to improve coverage, capacity, and power consumption within the wireless network.

For example, a UE may support multiple different types of RF thresholds, where a type of RF thresholds includes at least an in-band performance threshold and an out-of-band performance threshold for wireless communications. In some examples, the UE may transmit a message including capability information for the UE to a network entity. The capability information may indicate the types of RF thresholds supported by the UE, a mechanism for switching (e.g., dynamically, semi-statically, or both) between types of RF thresholds supported by the UE, or both. The network entity may receive the capability information and use the capability information to determine switching of RF threshold types for the UE. The network entity may determine a type of RF thresholds for the UE based on the UE's location within a cell of the network entity, cell load information for the cell, distributions of UEs or scheduled communications within the cell, priorities of communications, or any combination of these or other parameters.

The network entity may dynamically or semi-statically configure the UE with the type of RF thresholds. For example, the network entity may transmit, to the UE, a message indicating the type of RF thresholds (or the RF thresholds themselves corresponding to the determined type). The UE may select an RF configuration based on the configured type of RF thresholds and may communicate using the RF configuration. In some examples, switching to the RF configuration may involve the UE adjusting transmit power parameters, power amplifier (PA) parameters, or other parameters associated with RF communications. The UE's communications may satisfy the in-band and out-of-band performance thresholds based on the UE's RF configuration for the corresponding type of RF thresholds. Additionally, or alternatively, the network entity may coordinate configurations and scheduling across UEs, cells, or both to mitigate the effects of the UE's communications on other wireless devices (e.g., other UEs, network entities, or both).

Aspects of the disclosure are initially described in the context of wireless communications systems and process flows. Aspects of the disclosure are further illustrated by and described with reference to apparatus diagrams, system diagrams, and flowcharts that relate to configuration of a type of RF thresholds for a UE.

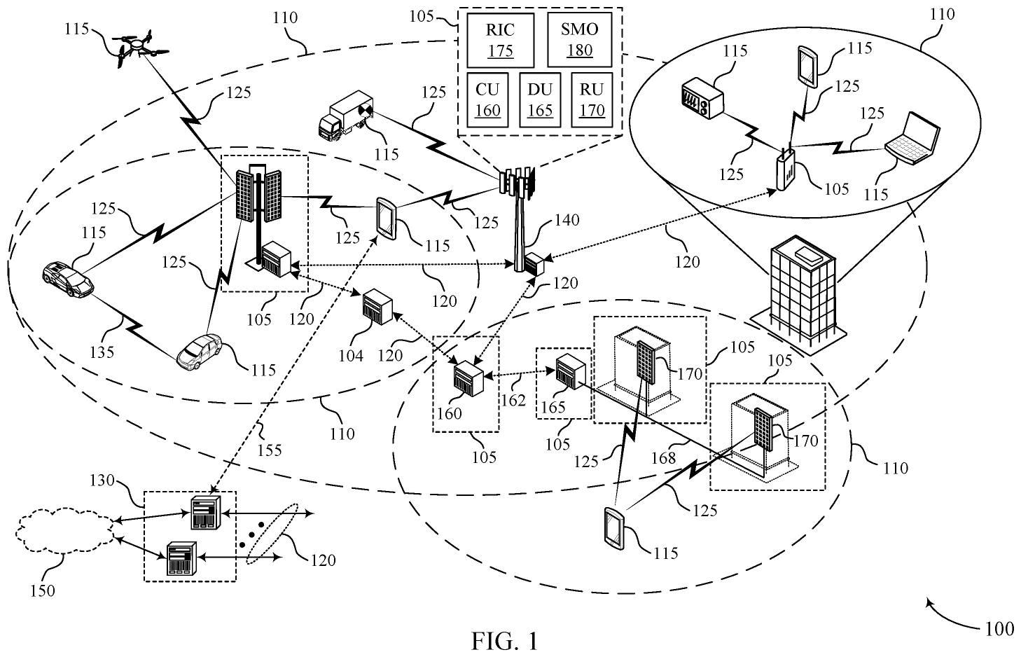

FIG. 1 shows an example of a wireless communications system 100 that supports configuration of a type of RF thresholds in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., an RF access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UEs 115 deployed in the wireless communications system 100 may meet, or otherwise satisfy, RF thresholds (e.g., RF conformance thresholds) of the wireless communications system 100, such as thresholds defined in a wireless standard (e.g., a Third Generation Partnership Project (3GPP) standard). For example, the UEs 115 may satisfy the RF thresholds under defined test conditions within a testing environment. The test conditions may include different frequencies for communications, different operating or ambient temperatures, different operating voltages, or any combination thereof. For uplink communications, the RF thresholds may include one or more in-band performance thresholds and one or more out-of-band performance thresholds. An in-band performance threshold may include an error vector magnitude (EVM) threshold, an in-band emission (IBE) threshold, or both for the frequency band (e.g., the BWP) via which a UE 115 transmits RF signals. An out-of-band performance threshold may include an adjacent channel leakage ratio (ACLR) threshold, a spectrum emissions mask (SEM) threshold, a spurious emissions threshold, or any combination thereof for frequencies external to the frequency band (e.g., the BWP) via which the UE 115 transmits the RF signals. To satisfy the in-band performance thresholds, the out-of-band performance thresholds, or both, the UE 115 may reduce a transmit power based on a transmitted waveform peak-to-average power ratio (PAPR) (e.g., based on a resource block allocation, modulation, or both for the transmissions). Additionally, or alternatively, the UE 115 may select a power amplifier (PA) bias value, a PA current value, or both to maintain linearity across operating transmit power levels for the transmissions. Such UE operations may support the UE 115 satisfying a performance threshold for the in-band transmissions, satisfying a threshold interference level or acceptable impact for other UEs 115, other technologies, public safety deployments, or any combination thereof operating via out-of-band frequencies.

However, in some cases, satisfying specific RF thresholds at a UE may cause a degradation in uplink throughput (e.g., due to a reduction in an uplink signal-to-noise ratio (SNR) for uplink transmissions) and a relatively higher power consumption or power overhead at the UE, which may negatively impact a day of use (DOU) for the UE. Additionally, or alternatively, satisfying the specific RF thresholds may cause a loss—or reduction—of coverage near a cell edge for a cell of a network entity. Accordingly, the UE operating based on the specific RF thresholds may degrade the UE's performance and negatively impact user experience for the UE.

To improve the UE and network performance based on RF thresholds, the wireless communications system 100 may support UE-network coordination of types of RF thresholds. The UE-network coordination may improve network coverage, UE capacity, and UE power consumption using network-configured types of RF thresholds. For example, a UE 115 may support multiple different types of RF thresholds, where a type of RF thresholds includes at least an in-band performance threshold and an out-of-band performance threshold. Different types of RF thresholds may support different in-band and out-of-band performance thresholds, allowing for improved flexibility in UE RF configurations. A network entity 105 may determine a type of RF thresholds for the UE 115 based on the UE's location within the cell of the network entity 105, cell load information for the cell, distributions of UEs 115 or scheduled communications within the cell, or some combination of these or other parameters. The network entity 105 may dynamically or semi-statically configure the UE 115 with the type of RF thresholds. The UE 115 may select an RF configuration based on the configured type of RF thresholds and may communicate using the RF configuration. The communications may satisfy the in-band and out-of-band performance thresholds for the configured type of RF thresholds. The network entity 105 may configure different types of RF thresholds for different UEs 115 in the cell. Additionally, or alternatively, the network entity 105 may configure different types of RF thresholds for the UE 115 to follow at different times based on current operating conditions for the UE 115, the cell, or both. In some examples, the network entity 105 and the UE 115 may use the different types of RF thresholds to improve the UE's performance while mitigating negative effects to other UEs 115 operating in the wireless communications system 100.

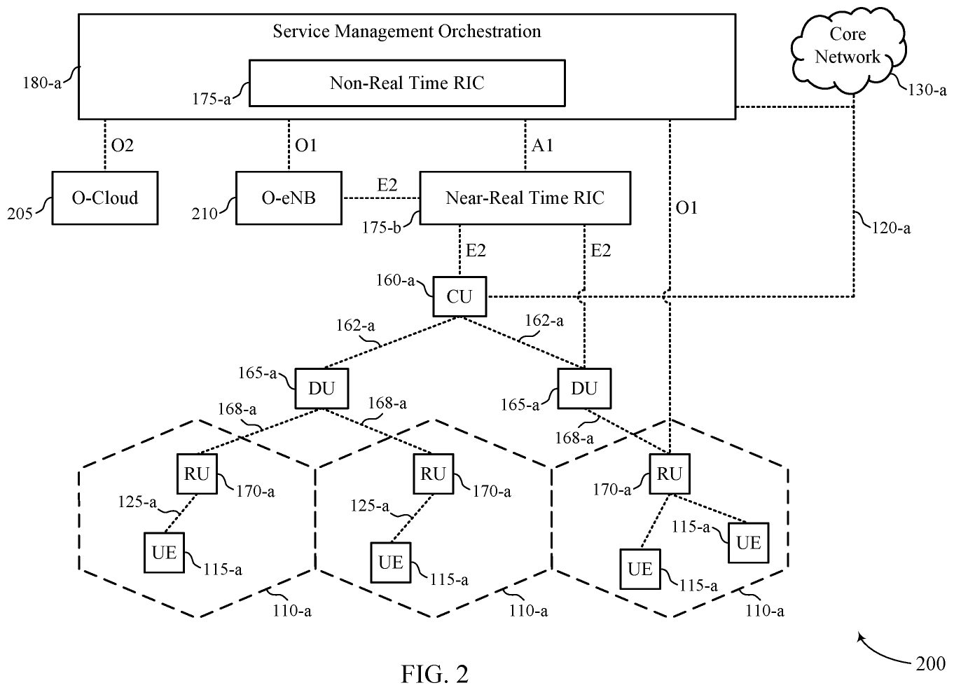

FIG. 2 shows an example of a network architecture 200 that supports configuration of a type of RF thresholds in accordance with one or more aspects of the present disclosure. The network architecture 200 may be an example of a disaggregated base station architecture, a disaggregated RAN architecture, or a combination thereof. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

A network entity 105, such as a CU 160-a, a DU 165-a, an RU 170-a, or any combination of these entities, may determine types of RF thresholds for different UEs 115-a and may coordinate between the different UEs 115-a (e.g., to ensure the type of RF thresholds configured for a first UE 115-a do not negatively impact communications for a second UE 115-a). The network entity 105 may be a single network entity 105 or a combination of one or more network entities 105. For example, a CU 160-a or a DU 165-a may select the type of RF thresholds for a UE 115-a and may manage coordination across the UEs 115-a of a cell (or the UEs 115-a of different cells). An RU 170-a may transmit a message indicating a configuration of the type of RF thresholds for a UE 115-a. Additionally, or alternatively, the RU 170-a may receive one or more messages from one or more UEs 115-a indicating UE capabilities, UE operating conditions, or other UE information. The RU 170-a may send the UE information to a DU 165-a or a CU 160-a to use for determining the types of RF thresholds for different UEs 115-a.

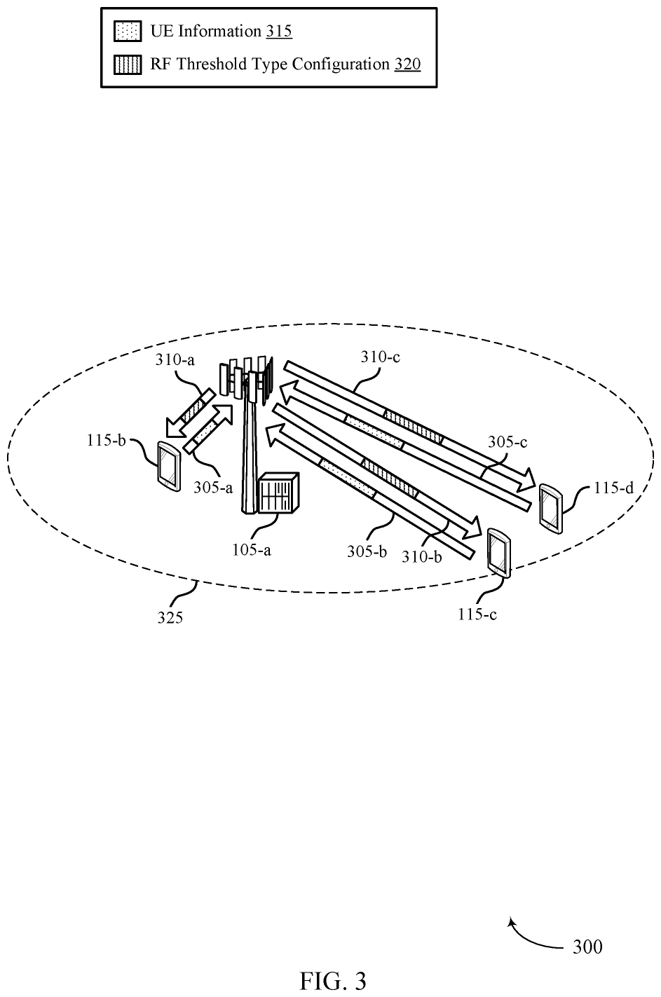

FIG. 3 shows an example of a wireless communications system 300 that supports configuration of a type of RF thresholds in accordance with one or more aspects of the present disclosure. The wireless communications system 300 may include a network entity 105-a, which may be an example of a network entity 105, a CU, a DU, an RU, or some combination thereof as described herein with reference to FIGS. 1 and 2. The wireless communications system 300 may additionally include a UE 115-b, a UE 115-c, and a UE 115-d, which may be examples of UEs 115 as described herein with reference to FIGS. 1 and 2. The network entity 105-a may provide network coverage for a cell 325. Based on one or more cell conditions, UE locations, or other parameters, the network entity 105-a may determine types of RF thresholds for the UEs 115 for improved performance.

The wireless communications system 300 may support different types of RF thresholds for communications. Some other systems may define a specific set of RF thresholds for a given technology (e.g., RAT), frequency band, bandwidth configuration, or a specific combination of these parameters. Such systems may restrict—or otherwise refrain from providing-flexibility for UE RF thresholds. In contrast, the wireless communications system 300 may support multiple sets of RF thresholds for a given technology (e.g., RAT), frequency band, bandwidth configuration, or specific combination of these parameters. Each “Type” may map to a specific set of RF thresholds (e.g., RF requirements) associated with in-band parameters, in-band thresholds, out-of-band parameters, out-of-band thresholds, or any combination thereof. For example, the wireless communications system 300 may support a Type 1 of RF thresholds defining a 256 quadrature amplitude modulation (QAM) EVM threshold of 3.5% and an ACLR threshold of-33 decibels (dB) (e.g., at the offsets of 1.6 MHz). Additionally, the wireless communications system 300 may support a Type 2 of RF thresholds defining a 256QAM EVM threshold of 4% and an ACLR threshold of-30 dB (e.g., at the offsets of 1.6 MHZ). Accordingly, Type 2 may correspond to relaxed thresholds (e.g., relaxed requirements) as compared to Type 1. The network may configure different UEs 115 with different types of RF thresholds to improve performance for the UEs 115.

In some examples, one type of RF thresholds (e.g., Type 1) may be an example of a default type of RF thresholds. UEs 115 may automatically communicate in accordance with the default type of RF thresholds unless configured (e.g., signaled) otherwise. In some cases, the default type of RF thresholds may include RAN4 uplink thresholds and metrics, defining radio performance and protocol aspects for UEs 115. Additionally, or alternatively, RAN4 may define multiple different sets of uplink thresholds and metrics for a UE 115 to meet (e.g., corresponding to the different types). For example, the RAN4 radio performance and protocol aspects may map sets of uplink metrics or thresholds (e.g., relaxed compared to the default metrics or thresholds) to the different types of RF thresholds. For example, a type of RF thresholds may map to a specific combination of ACLR threshold, SEM threshold, spurious emissions threshold, or some combination of these or other in-band or out-of-band thresholds.

In some examples, the UEs 115 may report UE information 315 to the network indicating UE capabilities and support for the different types of RF thresholds. For example, a first UE 115-b may report UE information 315 to a network entity 105-a via a first uplink channel 305-a, a second UE 115-c may report UE information 315 to the network entity 105-a via a second uplink channel 305-b, and a third UE 115-d may report UE information 315 to the network entity 105-a via a third uplink channel 305-c. The first UE 115-b may transmit the UE information 315 indicating the RF thresholds supported by the first UE 115-b. For example, the first UE 115-b and the network entity 105-a may store definitions of the different types of RF thresholds (e.g., a definition for Type 1, a definition for Type 2, and any further definitions for other types), and the first UE 115-b may report an indication of which types are supported by the first UE 115-b. In some cases, the first UE 115-b may indicate which types are supported for a given technology (e.g., RAT), frequency band, bandwidth configuration, or combination thereof. Additionally, or alternatively, the first UE 115-b may transmit the UE information 315 indicating an ability of the first UE 115-b to perform switching (e.g., dynamic switching, semi-static switching, or both) between different types of RF thresholds.

The network entity 105-a may receive the UE information 315 from one or more UEs 115. Based on the UE information 315 for respective UEs 115, the network entity 105-a may identify which UEs 115 can be configured with different types of RF configurations. Additionally, or alternatively, the network entity 105-a may identify which types are supported by a UE 115, how the UE 115 supports switching (e.g., dynamically, semi-statically, or both), or some combination thereof based on the UE information 315.

The network entity 105-a may use one or more parameters associated with the UEs 115, the cell 325, or both to determine a type of RF thresholds to assign to a UE 115. For example, the network entity 105-a may receive UE information 315 for the first UE 115-b and may determine that the first UE 115-b supports multiple types of RF thresholds and is capable of switching between the types. The network entity 105-a may determine to configure the UE 115-b with a type of RF thresholds based on a location of the UE 115-b within the cell 325, a distribution of different UEs 115 (e.g., the first UE 115-b compared to the second UE 115-c and the third UE 115-d) within the cell 325, or both. For example, the network entity 105-a may determine to configure the first UE 115-b with Type 1 RF thresholds based on the first UE 115-b being located relatively centrally within the cell 325, while the network entity 105-a may determine to configure the second UE 115-c with Type 2 RF thresholds based on the second UE 115-c being located relatively near an edge of the cell 325. The Type 2 RF thresholds may allow the second UE 115-c to communicate using RF parameters that mitigate the potential degradation of cell coverage near the edge of the cell 325.

Additionally, or alternatively, the network entity 105-a may determine to configure the first UE 115-b with a type of RF thresholds based on special case communications corresponding to relatively high priority communications, such as emergency calls (E-Calls), Next Generation (NG) E-Calls, or other mission critical scenarios or communications. For example, the network entity 105-a may determine that the first UE 115-b has a high priority communication pending transmission and may configure the first UE 115-b with a type of RF thresholds corresponding to relaxed transmission thresholds (e.g., as compared to default RF thresholds) to support the first UE 115-b transmitting the high priority communication using an increase transmit power or other adjusted RF configuration parameters to improve the throughput, reliability, or both of the high priority communication.

In some examples, a UE 115 may request a different type of RF thresholds. For example, the first UE 115-b may transmit a request (e.g., a UE assistance information (UAI) message including a request) to change a configured type of RF thresholds (e.g., to relax one or more RF thresholds) based on one or more operating parameters of the first UE 115-b. For example, the first UE 115-b may determine that it is operating with a relatively low battery power and may request a different type of RF thresholds that supports improved battery savings at the first UE 115-b. The first UE 115-b may transmit the request message to the network entity 105-a, and the network entity 105-a may respond by configuring the first UE 115-b with the requested type of RF thresholds or may reject the request (e.g., based on other UEs 115 that may be negatively affected if the first UE 115-b switches to communicating based on the requested type).

To configure the UE 115-b with a specific type of RF thresholds, the network entity 105-a may transmit an RF threshold type configuration 320 to the UE 115-b. For example, the RF threshold type configuration 320 may be an example of a message indicating a type of RF thresholds, the RF thresholds themselves associated with a specific type, or some combination thereof. The network entity 105-a may transmit, for the first UE 115-b via a first downlink channel 310-a, a first RF threshold type configuration 320. Additionally, or alternatively, the network entity 105-a may transmit, for the second UE 115-c via a second downlink channel 310-b, a second RF threshold type configuration 320 and may transmit, for the third UE 115-d via a third downlink channel 310-c, a third RF threshold type configuration 320.

A UE 115 receiving an indication of RF thresholds (e.g., the type or the corresponding thresholds) may use the indication of RF thresholds to determine an RF configuration for communications. In some cases, one or more UEs or types of UEs may be trained offline (e.g., at factory time) to map different types of RF thresholds to possible UE RF configurations, including a UE threshold transmit power (e.g., a maximum transmit power level (MTPL)), a PA amplifier characteristic, such as bias or current, or any combination of these or other RF configuration parameters. The trained RF configuration parameters corresponding to a specific type may satisfy the RF thresholds defined for that type. The UE 115-b may set one or more parameters for an RF configuration based on the offline training or based on a lookup table defined in accordance with offline training for one or more UEs 115 and the RF threshold type configuration 320 received by the UE 115-b. For example, based on the configured type of RF thresholds, the UE 115-b may set an RF configuration to meet (e.g., satisfy) the RF thresholds, which may allow the UE 115-b to improve a transmit power (e.g., a maximum transmit power) and a power consumption (e.g., power overhead) at the UE 115-b. In some examples, the UE 115-b may determine the new RF configuration or operating mode (e.g., mapping to updated RF configuration parameters, such as an updated MTPL and PA configuration) that supports the UE 115-b improving communication performance and coverage (e.g., potentially generating additional interference) while complying with the configured RF thresholds. Different UEs 115 may use different RF configuration parameters to meet (e.g., satisfy) the same type of RF thresholds, for example, if the different UEs 115 have different configurations, batteries, PA characteristics, transmitter configurations, or any combination thereof.

Rather than configure a UE 115 with specific RF configuration parameters, such as a transmit power or PA settings, the network entity 105-a may configure the UE 115 with the type of RF thresholds. Accordingly, the UE 115 may autonomously determine the RF configuration parameters that satisfy the thresholds of the type of RF thresholds, improving UE flexibility and supporting different UE, PA, and transmitter configurations. The UE 115 may adjust RF configuration parameters transparent to the network entity 105-a, reducing signaling overhead associated with the UE 115 RF configuration. Additionally, or alternatively, the network entity 105-a may refrain from tracking RF configuration information for different UEs 115 (e.g., instead tracking the configured types of RF thresholds for the different UEs 115), improving a processing and memory overhead at the network entity 105-a.

In some examples, the network entity 105-a may semi-statically configure the UE 115-b with a type of RF thresholds. For example, the RF threshold type configuration 320 may be an example or component of a radio resource control (RRC) message or a MAC control element (CE) indicating the type of RF thresholds. The RRC message or MAC-CE may configure the UE 115-b to communicate according to the indicated type of RF thresholds until the UE 115-b receives a subsequent RRC message or MAC-CE indicating a different type of RF thresholds or indicating for the UE 115-b to fall back to a default type of RF thresholds.

In some other examples, the network entity 105-a may dynamically configure the UE 115-b with a type of RF thresholds. For example, the RF threshold type configuration 320 may be an example or component of a downlink control information (DCI) message indicating the type of RF thresholds. In some examples, the DCI message may configure the UE 115-b to communicate according to the indicated type of RF thresholds for a specific time period (e.g., a specific transmission opportunity (TXOP), set of symbols, a set of slots, transmission time interval (TTI), or other time period). The UE 115-b may automatically switch back to communicating according to a default type of RF thresholds after the time period. In some cases, the DCI message may indicate the specific time period for the type of RF thresholds. For example, the DCI message may include one or more fields indicating a start time, an end time, a duration, or any combination thereof defining the time period. In some other cases, the UE 115-b may be configured to automatically switch to communicating according to the type of RF thresholds for a pre-defined or configured time period in response to the DCI message. For example, the DCI message may be an example of a grant for communications (e.g., uplink communications), and the configuration of the type of RF thresholds may be configured on a per-grant basis (e.g., configured for the granted communications but not other communications).

In some cases, the network entity 105-a may coordinate configurations, scheduling, or both for other UEs 115 (e.g., other UEs 115 in the cell 325) in accordance with a configuration of one UE 115. For example, the network entity 105-a may configure the UE 115-c with a type of RF thresholds corresponding to relaxed RF thresholds (e.g., based on the UE 115-c being located relatively near the cell edge for the network entity 105-a). In some examples, the network entity 105-a may determine to configure the UE 115-c with the relaxed RF thresholds based on a distance between the UE 115-c and the network entity 105-a satisfying (e.g., exceeding) a first threshold distance, a distance between the UE 115-c and the cell edge satisfying (e.g., being below) a second threshold distance, one or more channel metrics or other parameters associated with the UE 115-c satisfying (e.g., exceeding or being below) one or more thresholds, or any combination thereof. The UE 115-c may select an RF configuration for communications based on the relaxed RF thresholds. In some cases, such communications may potentially affect other UEs 115 relatively proximate to the UE 115-c (e.g., based on the relaxed RF thresholds). For example, based on the relaxed RF thresholds, the UE 115-c may transmit using a relatively higher transmit power (e.g., as compared to transmission in accordance with default RF thresholds), which may cause increased interference and lower SNR for other nearby devices (e.g., UEs 115, network entities 105).

For example, the UE 115-d may be relatively proximate to (e.g., within a threshold distance from) the UE 115-c. To support coordination between UEs 115, the network entity 105-a may intelligently schedule communications for the UE 115-d while the UE 115-c is operating according to the relaxed RF thresholds to mitigate (e.g., minimize, reduce) the impact of the communications for the UE 115-c on the communications for the UE 115-d. In some examples, one or more network entities 105 may support coordination within a same cell 325 or across cells 325 (e.g., with adjacent or otherwise nearby cells 325). The coordination may support coexistence between UEs 115 in a same virtual group. For example, the network entity 105-a may schedule the UE 115-d to backoff transmissions, communicate in different spatial directions than the UE 115-c, add additional buffers between the operating frequencies for the UE 115-c and the UE 115-d, or any combination of these or other techniques to mitigate the affect of one UE 115 on another. In some examples, the network entity 105-a may alter a grant to the UE 115-d (e.g., a UE 115 impacted by transmissions of the UE 115-c according to the relaxed RF thresholds) to use a relatively lower modulation and coding scheme (MCS) value that still meets an SNR threshold but mitigates the impact between the different UEs' communications. For example, the lower MCS may support decoding of the communications transmitted by the UE 115-d despite increased interference from the UE 115-c. Additionally, or alternatively, the network entity 105-a may schedule the UE 115-c on a first BWP and the potentially-affected UE 115-d on a second BWP different from the first BWP (and separately by a threshold quantity of frequency resources) to control—or otherwise mitigate—the amount of interference caused by the communications of the UE 115-c in accordance with relaxed RF thresholds on the communications of the UE 115-d. The network entity 105-a may perform similar coordination for other UEs 115 (e.g., other uplink-heavy UEs 115) to ensure a fair resource allocation scheme and improve user experience and an average cell throughput for the cell 325.

In some cases, the network entity 105-a may analyze operating conditions of other UEs 115 to determine whether to switch a type of RF thresholds for a UE 115. For example, the network entity 105-a may determine that the UE 115-c is power limited (e.g., based on remaining battery power or other features or conditions for the UE 115-c). The network entity 105-a may analyze operating conditions of the UE 115-d (e.g., other UEs 115 defined in a virtual group with the UE 115-c) to determine if the UE 115-d can cooperate with changes to the RF thresholds for the UE 115-c. In some examples, the network entity 105-a may signal for the UE 115-c to fall back to comply with a default type of RF thresholds based on the operating conditions of one or more nearby UEs 115.

In some examples, the network entity 105-a may perform frequency and bandwidth allocation to support coexistence between UEs 115 extending indirect assistance for other UEs 115 if the other UEs 115 are configured to communicate using different types of RF thresholds (e.g., relaxed thresholds). In some cases, the network entity 105-a may configure types of RF thresholds for different UEs 115 in a round-robin fashion (e.g., configuring a first UE 115 with relaxed thresholds for a first time period, configuring a second UE 115 with relaxed thresholds for a second time period subsequent to the first). For example, the network entity 105-a may use the round-robin configuration technique to improve coverage and reliability for cell edge UEs 115 while balancing uplink throughput and performance for the different UEs 115.

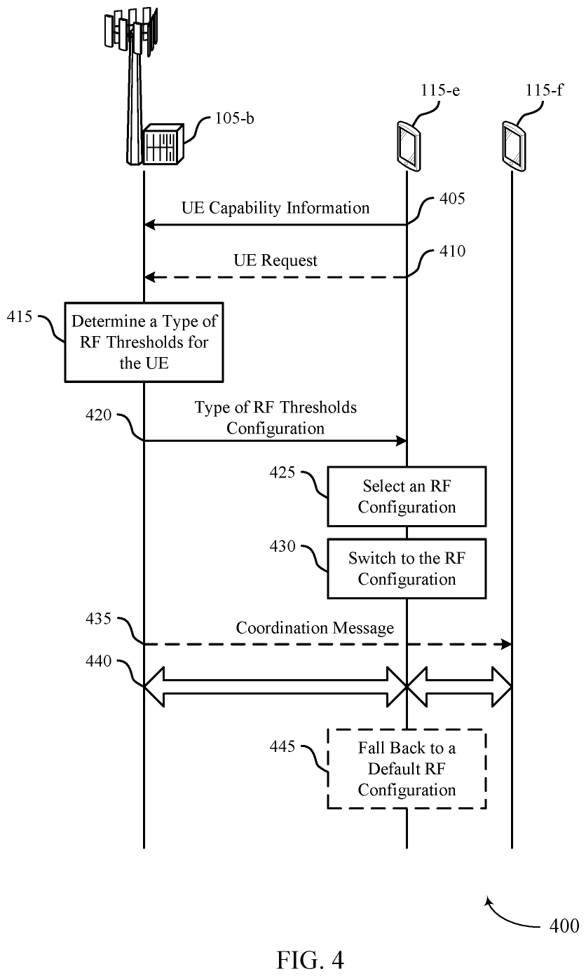

FIG. 4 shows an example of a process flow 400 that supports configuration of a type of RF thresholds in accordance with one or more aspects of the present disclosure. The process flow 400 may be performed by aspects of the wireless communications system 100, the network architecture 200, or the wireless communications system 300, as described herein with reference to FIGS. 1 through 3. For example, a network entity 105-b and a UE 115-c and UE 115-f, which may be examples of a network entity 105 and UEs 115 as described herein, may perform aspects of the process flow 400. In the following description of the process flow 400, operations performed by the network entity 105-b, the UE 115-c, and the UE 115-f may be performed in a different order than is shown. Some operations may be omitted from the process flow 400, and other operations may be added to the process flow 400. Further, although some operations or signaling may be shown to occur at different times for discussion purposes, these operations may occur at the same time. Additionally, or alternatively, other wireless devices may perform aspects of the process flow 400.

At 405, the UE 115-e may transmit UE information to the network entity 105-b. In some examples, the UE 115-c may transmit a message reporting a set of multiple types of RF thresholds supported by the UE 115-c. In some cases, different UEs 115 may support different type of RF thresholds. Additionally, or alternatively, the UE 115-c may transmit a message reporting a capability of the UE 115-c to dynamically (or semi-statically) switch between the supported types of RF thresholds. The network entity 105-b may receive the UE information and use the UE information to determine whether and how to configure a type of RF thresholds for the UE 115-c.

In some examples, at 410, the UE 115-e may transmit a message requesting a switch to a first type of RF thresholds (e.g., based on a current battery power of the UE 115-c, an active radio configuration for the UE 115-c, current channel metrics or throughput at the UE 115-c, or based on some other parameters). The request message may be an example of a UAI message. The network entity 105-b may receive the request message and determine whether to accept the request (e.g., configure the UE 115-e with the first type of RF thresholds) or deny the request (e.g., refrain from configuring the UE 115-e with the requested first type of RF thresholds).

At 415, the network entity 105-b may determine a first type of RF thresholds for the UE 115-e based on one or more parameters. For example, the network entity 105-b may determine the first type of RF thresholds based on a distribution of UEs 115 within a cell associated with the network entity 105-b, a location of the UE 115-e within the cell, a cell load for the cell, a scheduling distribution for communications associated with the UEs 115 within the cell, an application type for the UE 115-e (e.g., for a mission critical or other high priority application), a power threshold associated with the UE 115-c, a subscription plan associated with the UE 115-e (e.g., where different subscription plans may have different communication priority levels or allowed RF thresholds), or any combination thereof. In some examples, the network entity 105-b may determine the first type of RF thresholds for configuring the UE 115-e based on the UE information received at 405, the request message received at 410, or both.

At 420, the network entity 105-b may transmit, to the UE 115-c, a message that configures the UE 115-e with the first type of RF thresholds (e.g., from the set of multiple types of RF thresholds supported by the UE 115-e). The first type of RF thresholds may include at least an in-band performance threshold and an out-of-band performance threshold. In some examples, the first type of RF thresholds may indicate, or otherwise control, a signal quality for transmission at the UE 115-e. The message may be an example of an RRC message, a MAC-CE, a DCI message, or any combination thereof.

At 425, the UE 115-e may select an RF configuration for the UE 115-e based on the configured first type of RF thresholds. Selecting the RF configuration may involve the UE 115-e setting a PA bias value, a PA current value, a threshold transmit power level, or any combination thereof to satisfy the configured first type of RF thresholds (e.g., to satisfy the in-band and out-of-band thresholds or requirements). In some examples, the UE 115-e may store a lookup table that maps one or more types of RF thresholds to one or more respective RF configurations for the UE 115-c. The UE 115-c may use the lookup table to look up the RF configuration corresponding to the configured first type of RF thresholds or to infer the RF configuration based on one or more other RF configurations stored in the lookup table (e.g., for other types of RF thresholds). For example, the lookup table may be a partial or full lookup table representing partial or full mappings of RF threshold types. In some cases, the lookup table may be based on offline training by the UE 115-e or one or more other UEs 115.

At 430, the UE 115-e may switch to the selected RF configuration for communications. The UE 115-c may dynamically switch to the RF configuration for a specific time period or may semi-statically switch to the RF configuration until a different configuration of RF threshold type is received by the UE 115-c.

In some examples, at 435, the network entity 105-b may coordinate between the UE 115-c and a UE 115-f (e.g., a UE 115-f neighboring, or otherwise within a threshold distance from, the UE 115-c). For example, the type of RF thresholds configured for the UE 115-e may potentially increase interference caused by communications of the UE 115-c. The network entity 105-b may schedule or otherwise configure the UE 115-f to mitigate any negative effects from the increased interference. In some examples, the network entity 105-b may schedule one or more communications for the UE 115-f based on the RF configuration of the UE 115-e (e.g., to mitigate the effects of interference). Additionally, or alternatively, the network entity 105-b may determine a first BWP associated with the RF configuration of the UE 115-c and may schedule communications of the UE 115-f for a second BWP different from the first BWP. In some examples, the network entity 105-b may predict interference associated with communications of the UE 115-e and may schedule communications for the UE 115-f based on the predicted interference. Additionally, or alternatively, the network entity 105-b may configure the UE 115-f with an MCS value for communications based on the predicted interference. In some examples, the network entity 105-b may configure the UE 115-f with a type of RF thresholds (e.g., a second, different type of RF thresholds) based on the first type of RF thresholds configured for the UE 115-c.

At 440, the UE 115-e may communicate according to the selected RF configuration. The UE 115-e may transmit one or more uplink message, transmit one or more sidelink messages, receive one or more sidelink messages, receive one or more downlink messages, or any combination thereof using the selected RF configuration. For example, the UE 115-e may transmit a message that satisfies the in-band performance threshold and the out-of-band performance threshold for the first type of RF thresholds based on the selected RF configuration for the UE 115-e corresponding ot the first type of RF thresholds.

In some examples, at 445, the UE 115-e may automatically fall back to communicating according to a default type of RF thresholds, for example, if the UE 115-e is dynamically configured with the first type of RF thresholds for a specific time period.

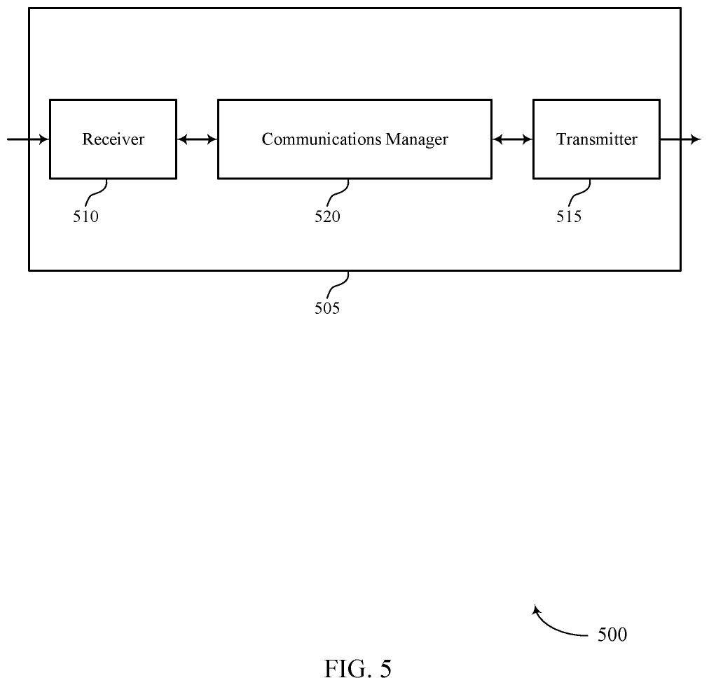

FIG. 5 shows a block diagram 500 of a device 505 that supports configuration of a type of RF thresholds in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to configuration of a type of RF thresholds). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to configuration of a type of RF thresholds). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of configuration of a type of RF thresholds as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for receiving a first message that configures the UE with a first type of RF thresholds from a set of multiple types of RF thresholds supported by the UE, the first type of RF thresholds including at least an in-band performance threshold and an out-of-band performance threshold. The communications manager 520 is capable of, configured to, or operable to support a means for transmitting a second message that satisfies the in-band performance threshold and the out-of-band performance threshold based on an RF configuration for the UE corresponding to the first type of RF thresholds.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption. For example, the communications manager 520 may set an RF configuration that improves the processing and power overhead for communications at the UE.

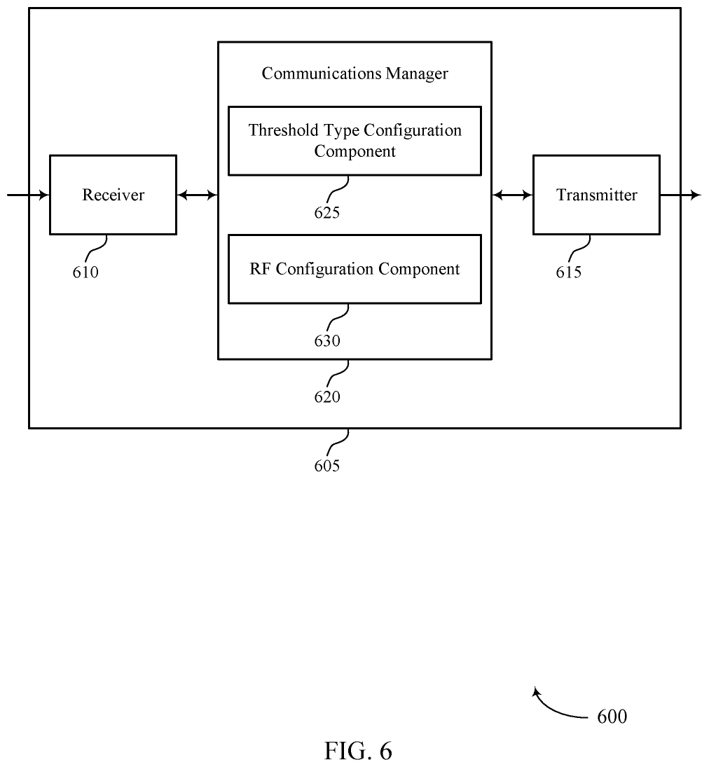

FIG. 6 shows a block diagram 600 of a device 605 that supports configuration of a type of RF thresholds in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to configuration of a type of RF thresholds). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuration of a type of RF thresholds). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of configuration of a type of RF thresholds as described herein. For example, the communications manager 620 may include a threshold type configuration component 625, an RF configuration component 630, or both. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The threshold type configuration component 625 is capable of, configured to, or operable to support a means for receiving a first message that configures the UE with a first type of RF thresholds from a set of multiple types of RF thresholds supported by the UE, the first type of RF thresholds including at least an in-band performance threshold and an out-of-band performance threshold. The RF configuration component 630 is capable of, configured to, or operable to support a means for transmitting a second message that satisfies the in-band performance threshold and the out-of-band performance threshold based on an RF configuration for the UE corresponding to the first type of RF thresholds.

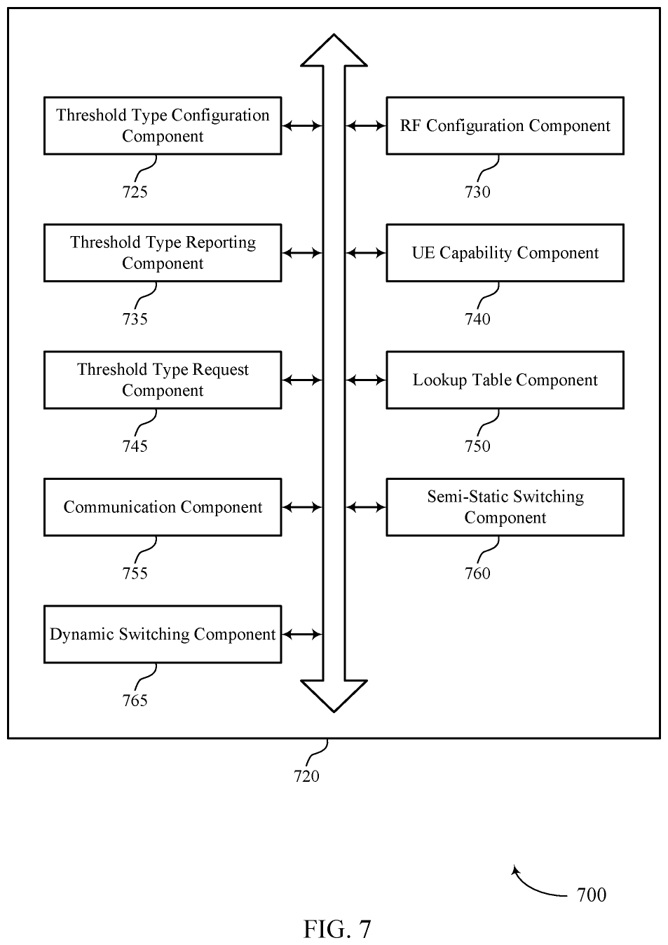

FIG. 7 shows a block diagram 700 of a communications manager 720 that supports configuration of a type of RF thresholds in accordance with one or more aspects of the present disclosure. The communications manager 720 may be an example of aspects of a communications manager 520, a communications manager 620, or both, as described herein. The communications manager 720, or various components thereof, may be an example of means for performing various aspects of configuration of a type of RF thresholds as described herein. For example, the communications manager 720 may include a threshold type configuration component 725, an RF configuration component 730, a threshold type reporting component 735, a UE capability component 740, a threshold type request component 745, a lookup table component 750, a communication component 755, a semi-static switching component 760, a dynamic switching component 765, or any combination thereof. Each of these components, or components or subcomponents thereof (e.g., one or more processors, one or more memories), may communicate, directly or indirectly, with one another (e.g., via one or more buses).

The communications manager 720 may support wireless communications at a UE in accordance with examples as disclosed herein. The threshold type configuration component 725 is capable of, configured to, or operable to support a means for receiving (or otherwise obtaining) a first message that configures the UE with a first type of RF thresholds from a set of multiple types of RF thresholds supported by the UE, the first type of RF thresholds including at least an in-band performance threshold and an out-of-band performance threshold. The RF configuration component 730 is capable of, configured to, or operable to support a means for transmitting (or otherwise outputting) a second message that satisfies the in-band performance threshold and the out-of-band performance threshold based on an RF configuration for the UE corresponding to the first type of RF thresholds.

In some examples, the RF configuration component 730 is capable of, configured to, or operable to support a means for selecting the RF configuration for the UE based on the first message.

In some examples, to support selecting the RF configuration for the UE, the RF configuration component 730 is capable of, configured to, or operable to support a means for setting a PA bias value, a PA current value, a threshold transmit power level, or a combination thereof for the UE, where the second message is transmitted according to the PA bias value, the PA current value, the threshold transmit power level, or the combination thereof.

In some examples, the threshold type reporting component 735 is capable of, configured to, or operable to support a means for transmitting a third message reporting the set of multiple types of RF thresholds supported by the UE, where the first message that configures the UE is in accordance with the third message.

In some examples, the UE capability component 740 is capable of, configured to, or operable to support a means for transmitting a fourth message reporting a capability of the UE to dynamically switch between the set of multiple types of RF thresholds supported by the UE, where the first message is received based on the capability of the UE.

In some examples, the threshold type request component 745 is capable of, configured to, or operable to support a means for transmitting a fifth message requesting to switch to the first type of RF thresholds based on a current battery power of the UE, an active radio configuration for the UE, or both, where the first message is received based on the fifth message. In some examples, the fifth message includes a UAI message.

In some examples, the first message includes a first RRC message, a first MAC-CE, or a first combination thereof. In some examples, the semi-static switching component 760 is capable of, configured to, or operable to support a means for switching to the RF configuration for the UE based on the first RRC message, the first MAC-CE, or the first combination thereof. In some examples, the semi-static switching component 760 is capable of, configured to, or operable to support a means for receiving a second RRC message, a second MAC-CE, or a second combination thereof that configures the UE with a second type of RF thresholds from the set of multiple types of RF thresholds supported by the UE. In some examples, the semi-static switching component 760 is capable of, configured to, or operable to support a means for switching to a second RF configuration for the UE corresponding to the second type of RF thresholds based on the second RRC message, the second MAC-CE, or the second combination thereof.

In some other examples, the first message includes a DCI message. In some examples, the dynamic switching component 765 is capable of, configured to, or operable to support a means for switching from a first RF configuration for the UE to the RF configuration for the UE for a TXOP associated with the second message based on the DCI message indicating the TXOP. In some examples, the dynamic switching component 765 is capable of, configured to, or operable to support a means for switching back to the first RF configuration for the UE for a subsequent TXOP.

In some examples, the RF configuration component 730 is capable of, configured to, or operable to support a means for communicating in accordance with a default type of RF thresholds prior to receiving the first message that configures the UE with the first type of RF thresholds.

In some examples, the lookup table component 750 is capable of, configured to, or operable to support a means for storing a lookup table that maps one or more types of RF thresholds from the set of multiple types of RF thresholds supported by the UE to one or more respective RF configurations for the UE. In some examples, the lookup table component 750 is capable of, configured to, or operable to support a means for determining the RF configuration for the UE corresponding to the first type of RF thresholds based on the lookup table.

In some examples, the communication component 755 is capable of, configured to, or operable to support a means for communicating one or more uplink messages, one or more sidelink messages, one or more downlink messages, or any combination thereof based on the RF configuration for the UE.

In some examples, the first type of RF thresholds indicates a signal quality for transmission at the UE. In some examples, the second message is transmitted based on the signal quality for transmission.

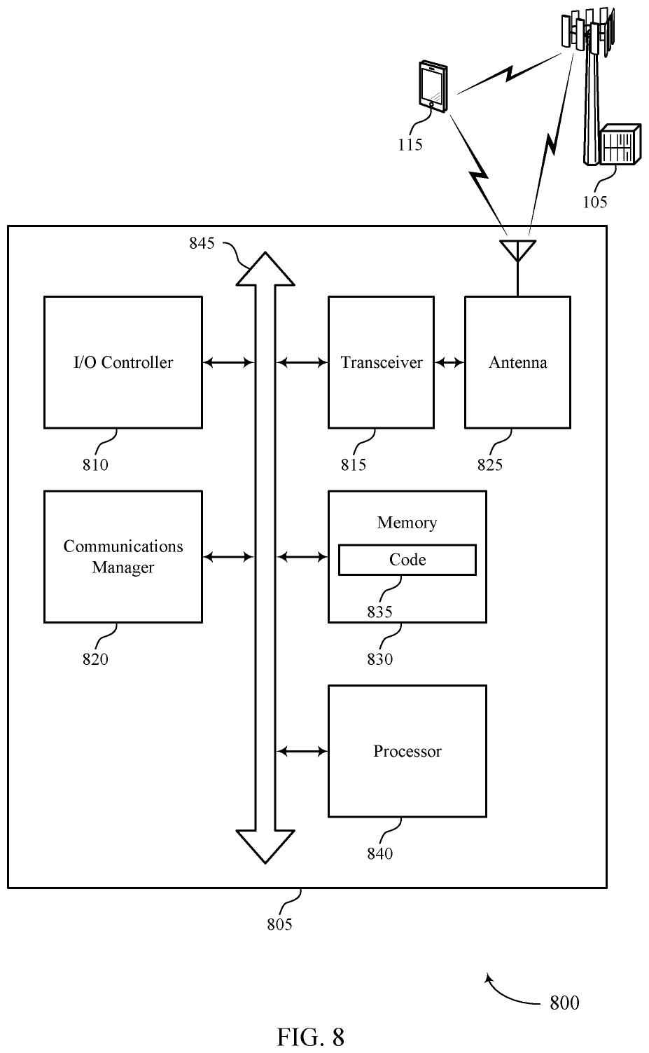

FIG. 8 shows a diagram of a system 800 including a device 805 that supports configuration of a type of RF thresholds in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting configuration of a type of RF thresholds). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications at a UE in accordance with examples as disclosed herein. For example, the communications manager 820 is capable of, configured to, or operable to support a means for receiving a first message that configures the UE with a first type of RF thresholds from a set of multiple types of RF thresholds supported by the UE, the first type of RF thresholds including at least an in-band performance threshold and an out-of-band performance threshold. The communications manager 820 is capable of, configured to, or operable to support a means for transmitting a second message that satisfies the in-band performance threshold and the out-of-band performance threshold based on an RF configuration for the UE corresponding to the first type of RF thresholds.

By including or configuring the communications manager 820 in accordance with examples as described herein, the device 805 may support techniques for improved communication reliability, improved user experience related to reduced processing, reduced power consumption, longer battery life, improved utilization of processing capability, or any combination thereof. For example, the device 805 may switch to an RF configuration that supports increased transmit power, improves PA utilization, or both to improve signaling reliability and throughput.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of configuration of a type of RF thresholds as described herein, or the at least one processor 840 and the at least one memory 830 may be otherwise configured to, individually or collectively, perform or support such operations.

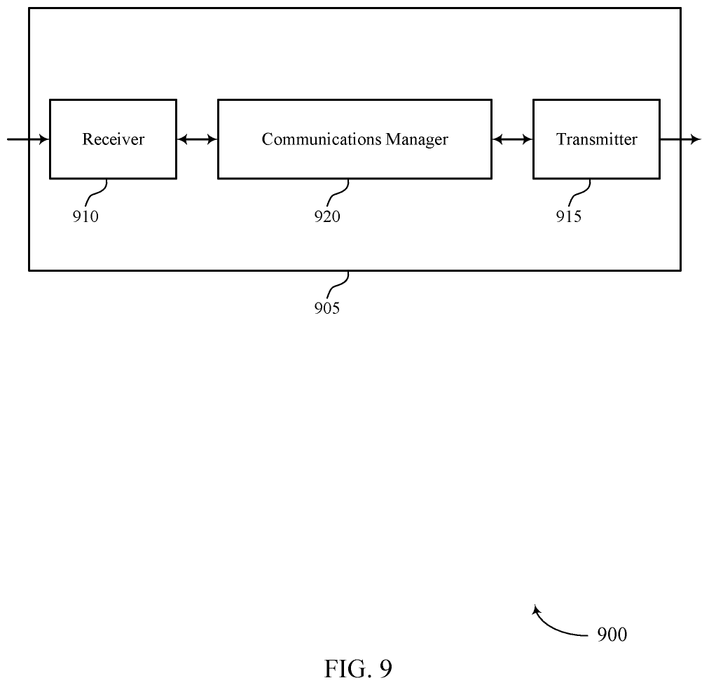

FIG. 9 shows a block diagram 900 of a device 905 that supports configuration of a type of RF thresholds in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of configuration of a type of RF thresholds as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for transmitting, for a UE, a first message that configures the UE with a first type of RF thresholds from a set of multiple types of RF thresholds supported by the UE, the first type of RF thresholds including at least an in-band performance threshold and an out-of-band performance threshold. The communications manager 920 is capable of, configured to, or operable to support a means for receiving a second message that satisfies the in-band performance threshold and the out-of-band performance threshold based on an RF configuration for the UE corresponding to the first type of RF thresholds.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

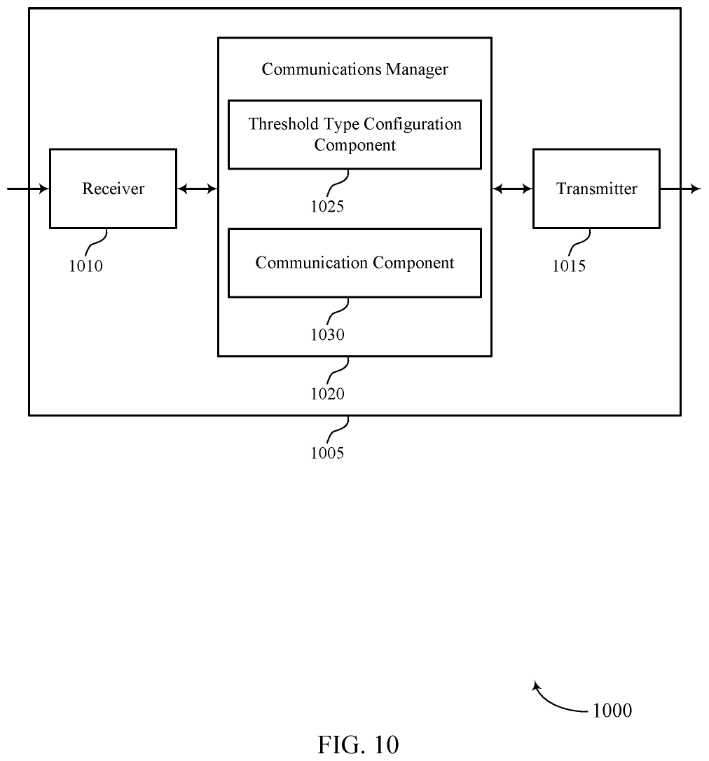

FIG. 10 shows a block diagram 1000 of a device 1005 that supports configuration of a type of RF thresholds in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of configuration of a type of RF thresholds as described herein. For example, the communications manager 1020 may include a threshold type configuration component 1025, a communication component 1030, or both. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The threshold type configuration component 1025 is capable of, configured to, or operable to support a means for transmitting, for a UE, a first message that configures the UE with a first type of RF thresholds from a set of multiple types of RF thresholds supported by the UE, the first type of RF thresholds including at least an in-band performance threshold and an out-of-band performance threshold. The communication component 1030 is capable of, configured to, or operable to support a means for receiving a second message that satisfies the in-band performance threshold and the out-of-band performance threshold based on an RF configuration for the UE corresponding to the first type of RF thresholds.

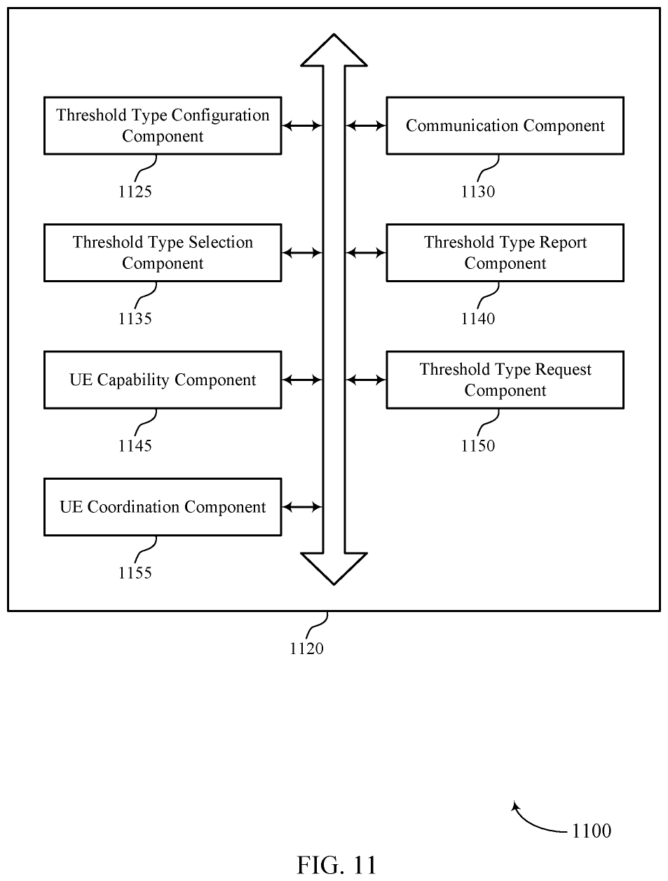

FIG. 11 shows a block diagram 1100 of a communications manager 1120 that supports configuration of a type of RF thresholds in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of configuration of a type of RF thresholds as described herein. For example, the communications manager 1120 may include a threshold type configuration component 1125, a communication component 1130, a threshold type selection component 1135, a threshold type report component 1140, a UE capability component 1145, a threshold type request component 1150, a UE coordination component 1155, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The threshold type configuration component 1125 is capable of, configured to, or operable to support a means for transmitting (or otherwise outputting, for a UE (e.g., to the UE), a first message that configures the UE with a first type of RF thresholds from a set of multiple types of RF thresholds supported by the UE, the first type of RF thresholds including at least an in-band performance threshold and an out-of-band performance threshold. The communication component 1130 is capable of, configured to, or operable to support a means for receiving (or otherwise obtaining) a second message that satisfies the in-band performance threshold and the out-of-band performance threshold based on an RF configuration for the UE corresponding to the first type of RF thresholds.

In some examples, the threshold type selection component 1135 is capable of, configured to, or operable to support a means for determining the first type of RF thresholds for the UE based on a distribution of UEs within a cell associated with the network entity, a location of the UE within the cell, a cell load for the cell, a scheduling distribution for communications associated with the UEs within the cell, an application type for the UE, a power threshold associated with the UE, a subscription plan associated with the UE, or any combination thereof.

In some examples, the threshold type report component 1140 is capable of, configured to, or operable to support a means for receiving a third message reporting the set of multiple types of RF thresholds supported by the UE, where the RF configuration for the UE is in accordance with the third message.

In some examples, the UE capability component 1145 is capable of, configured to, or operable to support a means for receiving a fourth message reporting a capability of the UE to dynamically switch between the set of multiple types of RF thresholds supported by the UE, where the first message is transmitted based on the capability of the UE.

In some examples, the threshold type request component 1150 is capable of, configured to, or operable to support a means for receiving a fifth message requesting for the UE to switch to the first type of radio frequency thresholds, where the first message is transmitted based on the fifth message.

In some examples, the UE coordination component 1155 is capable of, configured to, or operable to support a means for transmitting, for a second UE different from the UE, a sixth message scheduling one or more communications for the second UE based on the RF configuration for the UE.

In some examples, the UE coordination component 1155 is capable of, configured to, or operable to support a means for determining a first BWP associated with the RF configuration for the UE. In some examples, the UE coordination component 1155 is capable of, configured to, or operable to support a means for scheduling the one or more communications for the second UE for a second BWP different from the first BWP based on the RF configuration for the UE.

In some examples, the UE coordination component 1155 is capable of, configured to, or operable to support a means for predicting interference associated with the second message based on the first type of RF thresholds configured for the UE. In some examples, the UE coordination component 1155 is capable of, configured to, or operable to support a means for scheduling the one or more communications for the second UE based on the predicted interference.

In some examples, the UE coordination component 1155 is capable of, configured to, or operable to support a means for transmitting, for a second UE different from the UE, a seventh message that configures the second UE with a second type of RF thresholds from a second set of multiple types of RF thresholds supported by the second UE based on the first type of RF thresholds configured for the UE.

In some examples, the UE coordination component 1155 is capable of, configured to, or operable to support a means for transmitting, for a second UE different from the UE, an eight message that configures the second UE with an MCS value based on a predicted impact of the first type of RF thresholds configured for the UE on the second UE.

In some examples, the first message includes an RRC message, a MAC-CE, a DCI message, or any combination thereof.

In some examples, the communication component 1130 is capable of, configured to, or operable to support a means for communicating one or more uplink messages, one or more downlink messages, or any combination thereof based on the RF configuration for the UE.

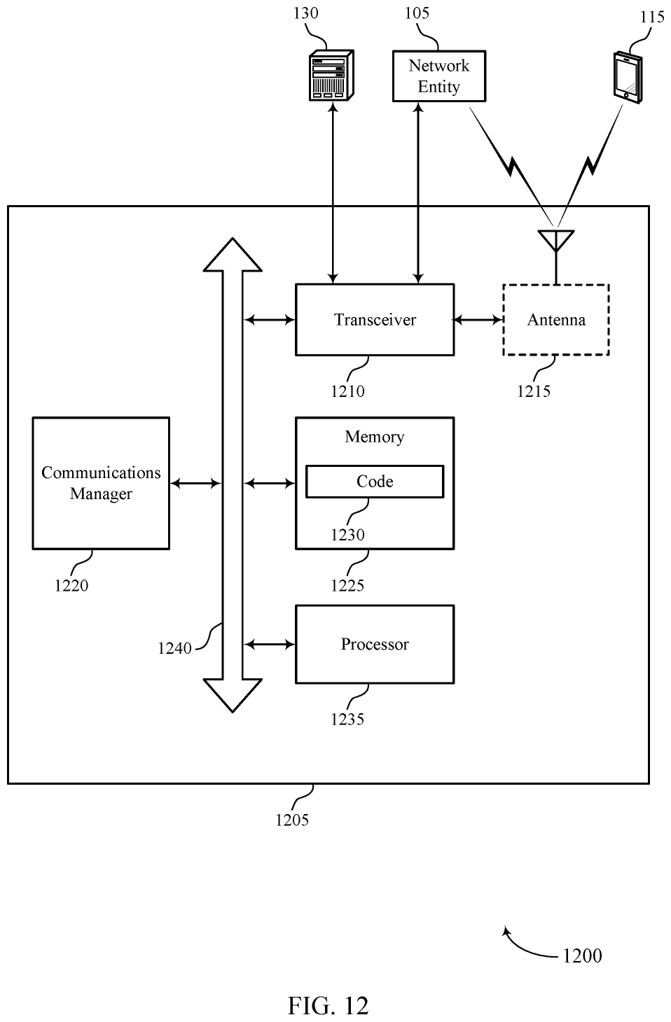

FIG. 12 shows a diagram of a system 1200 including a device 1205 that supports configuration of a type of RF thresholds in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting configuration of a type of RF thresholds). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105 and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for transmitting, for a UE, a first message that configures the UE with a first type of RF thresholds from a set of multiple types of RF thresholds supported by the UE, the first type of RF thresholds including at least an in-band performance threshold and an out-of-band performance threshold. The communications manager 1220 is capable of, configured to, or operable to support a means for receiving a second message that satisfies the in-band performance threshold and the out-of-band performance threshold based on an RF configuration for the UE corresponding to the first type of RF thresholds.

By including or configuring the communications manager 1220 in accordance with examples as described herein, the device 1205 may support techniques for improved communication reliability, improved user experience related to reduced processing, improved coordination between devices, longer battery life, improved utilization of processing capability, or any combination thereof.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of configuration of a type of RF thresholds as described herein, or the at least one processor 1235 and the at least one memory 1225 may be otherwise configured to, individually or collectively, perform or support such operations.

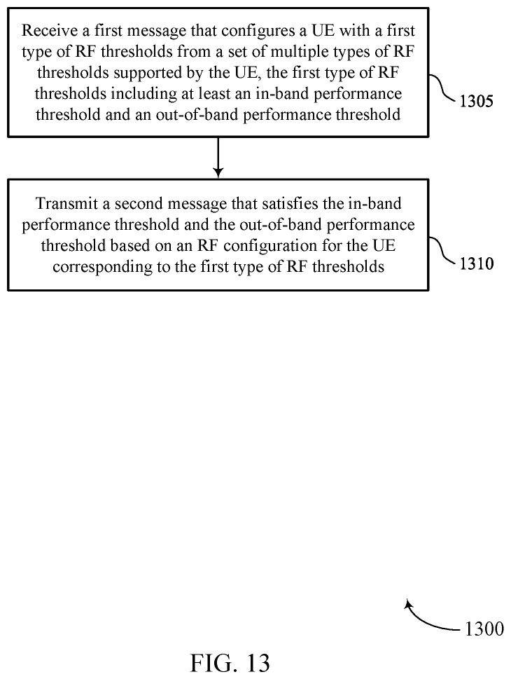

FIG. 13 shows a flowchart illustrating a method 1300 that supports configuration of a type of RF thresholds in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first message that configures the UE with a first type of RF thresholds from a set of multiple types of RF thresholds supported by the UE. The first type of RF thresholds may include at least an in-band performance threshold and an out-of-band performance threshold. The operations of 1305 may be performed in accordance with examples as disclosed herein. In some examples, aspects of the operations of 1305 may be performed by a threshold type configuration component 725 as described with reference to FIG. 7.

At 1310, the method may include transmitting a second message that satisfies the in-band performance threshold and the out-of-band performance threshold based on an RF configuration for the UE corresponding to the first type of RF thresholds. The operations of 1310 may be performed in accordance with examples as disclosed herein. In some examples, aspects of the operations of 1310 may be performed by an RF configuration component 730 as described with reference to FIG. 7.

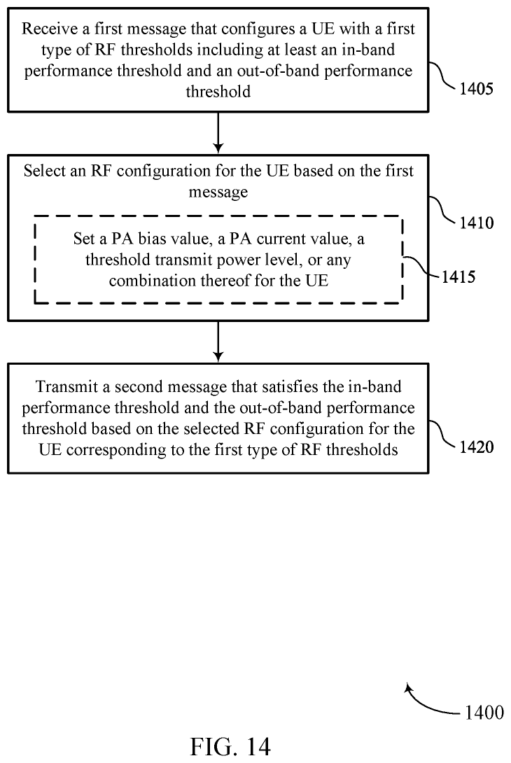

FIG. 14 shows a flowchart illustrating a method 1400 that supports configuration of a type of RF thresholds in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a first message that configures the UE with a first type of RF thresholds from a set of multiple types of RF thresholds supported by the UE. The first type of RF thresholds includes at least an in-band performance threshold and an out-of-band performance threshold. The operations of 1405 may be performed in accordance with examples as disclosed herein. In some examples, aspects of the operations of 1405 may be performed by a threshold type configuration component 725 as described with reference to FIG. 7.

At 1410, the method may include selecting an RF configuration for the UE based on the first message. The operations of 1410 may be performed in accordance with examples as disclosed herein. In some examples, aspects of the operations of 1410 may be performed by an RF configuration component 730 as described with reference to FIG. 7.

At 1415, the method may include setting a PA bias value, a PA current value, a threshold transmit power level, or any combination thereof for the UE. The operations of 1415 may be performed in accordance with examples as disclosed herein. In some examples, aspects of the operations of 1415 may be performed by an RF configuration component 730 as described with reference to FIG. 7.

At 1420, the method may include transmitting a second message that satisfies the in-band performance threshold and the out-of-band performance threshold based on the RF configuration for the UE corresponding to the first type of RF thresholds. For example, the method may include transmitting the second message using the configured PA bias value, PA current value, threshold transmit power level, or combination thereof. The operations of 1420 may be performed in accordance with examples as disclosed herein. In some examples, aspects of the operations of 1420 may be performed by an RF configuration component 730 as described with reference to FIG. 7.

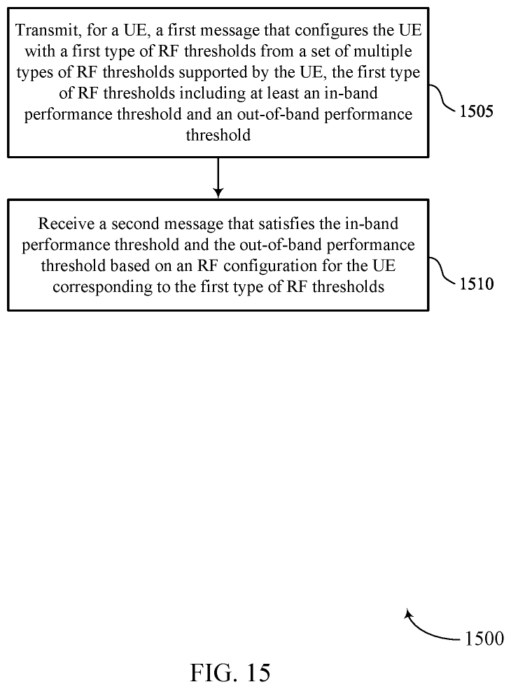

FIG. 15 shows a flowchart illustrating a method 1500 that supports configuration of a type of RF thresholds in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, for a UE, a first message that configures the UE with a first type of RF thresholds from a set of multiple types of RF thresholds supported by the UE. The first type of RF thresholds includes at least an in-band performance threshold and an out-of-band performance threshold. The operations of 1505 may be performed in accordance with examples as disclosed herein. In some examples, aspects of the operations of 1505 may be performed by a threshold type configuration component 1125 as described with reference to FIG. 11.

At 1510, the method may include receiving a second message that satisfies the in-band performance threshold and the out-of-band performance threshold based on an RF configuration for the UE corresponding to the first type of RF thresholds. The operations of 1510 may be performed in accordance with examples as disclosed herein. In some examples, aspects of the operations of 1510 may be performed by a communication component 1130 as described with reference to FIG. 11.

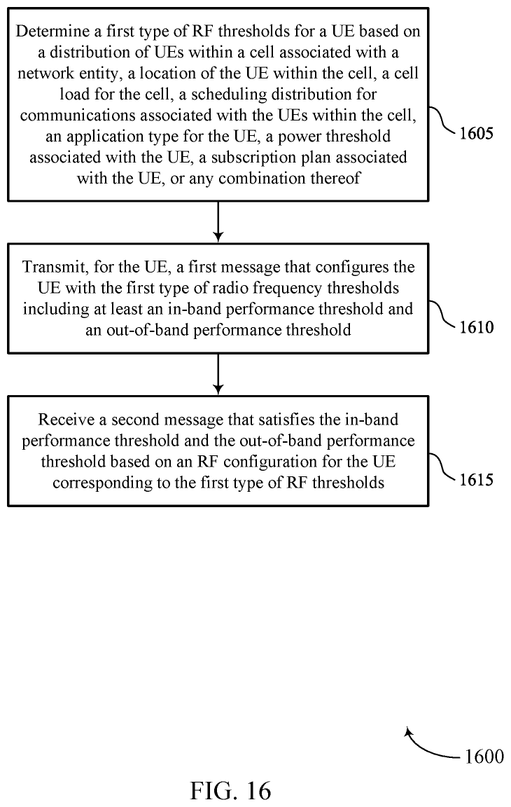

FIG. 16 shows a flowchart illustrating a method 1600 that supports configuration of a type of RF thresholds in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include determining a first type of RF thresholds for a UE. For example, the method may include determining the first type of RF thresholds based on a distribution of UEs within a cell associated with the network entity, a location of the UE within the cell, a cell load for the cell, a scheduling distribution for communications associated with the UEs within the cell, an application type for the UE, a power threshold associated with the UE, a subscription plan associated with the UE, or any combination thereof. The operations of 1605 may be performed in accordance with examples as disclosed herein. In some examples, aspects of the operations of 1605 may be performed by a threshold type selection component 1135 as described with reference to FIG. 11.

At 1610, the method may include transmitting, for a UE, a first message that configures the UE with the first type of RF thresholds from a set of multiple types of RF thresholds supported by the UE. The first type of RF thresholds includes at least an in-band performance threshold and an out-of-band performance threshold. The operations of 1610 may be performed in accordance with examples as disclosed herein. In some examples, aspects of the operations of 1610 may be performed by a threshold type configuration component 1125 as described with reference to FIG. 11.

At 1615, the method may include receiving a second message that satisfies the in-band performance threshold and the out-of-band performance threshold based on an RF configuration for the UE corresponding to the first type of RF thresholds. The operations of 1615 may be performed in accordance with examples as disclosed herein. In some examples, aspects of the operations of 1615 may be performed by a communication component 1130 as described with reference to FIG. 11.

The following provides an overview of aspects of the present disclosure:

Aspect 1: A method for wireless communications at a UE, comprising: receiving a first message that configures the UE with a first type of RF thresholds from a plurality of types of RF thresholds supported by the UE, the first type of RF thresholds comprising at least an in-band performance threshold and an out-of-band performance threshold; and transmitting a second message that satisfies the in-band performance threshold and the out-of-band performance threshold based at least in part on an RF configuration for the UE corresponding to the first type of RF thresholds.

Aspect 2: The method of aspect 1, further comprising: selecting the RF configuration for the UE based at least in part on the first message.

Aspect 3: The method of aspect 2, wherein selecting the RF configuration for the UE comprises: setting a PA bias value, a PA current value, a threshold transmit power level, or a combination thereof for the UE, wherein the second message is transmitted according to the PA bias value, the PA current value, the threshold transmit power level, or the combination thereof.

Aspect 4: The method of any of aspects 1 through 3, further comprising: transmitting a third message reporting the plurality of types of RF thresholds supported by the UE, wherein the first message that configures the UE is in accordance with the third message.

Aspect 5: The method of any of aspects 1 through 4, further comprising: transmitting a fourth message reporting a capability of the UE to dynamically switch between the plurality of types of RF thresholds supported by the UE, wherein the first message is received based at least in part on the capability of the UE.

Aspect 6: The method of any of aspects 1 through 5, further comprising: transmitting a fifth message requesting to switch to the first type of RF thresholds based at least in part on a current battery power of the UE, an active radio configuration for the UE, or both, wherein the first message is received based at least in part on the fifth message.

Aspect 7: The method of aspect 6, wherein the fifth message comprises a UAI message.

Aspect 8: The method of any of aspects 1 through 7, wherein the first message comprises a first RRC message, a first MAC-CE, or a first combination thereof.

Aspect 9: The method of aspect 8, further comprising: switching to the RF configuration for the UE based at least in part on the first RRC message, the first MAC-CE, or the first combination thereof; receiving a second RRC message, a second MAC-CE, or a second combination thereof that configures the UE with a second type of RF thresholds from the plurality of types of RF thresholds supported by the UE; and switching to a second RF configuration for the UE corresponding to the second type of RF thresholds based at least in part on the second RRC message, the second MAC-CE, or the second combination thereof.

Aspect 10: The method of any of aspects 1 through 7, wherein the first message comprises a DCI message.

Aspect 11: The method of aspect 10, further comprising: switching from a first RF configuration for the UE to the RF configuration for the UE for a TXOP associated with the second message based at least in part on the DCI message indicating the TXOP; and switching back to the first RF configuration for the UE for a subsequent TXOP.

Aspect 12: The method of any of aspects 1 through 11, further comprising: communicating in accordance with a default type of RF thresholds prior to receiving the first message that configures the UE with the first type of RF thresholds.

Aspect 13: The method of any of aspects 1 through 12, further comprising: storing a lookup table that maps one or more types of RF thresholds from the plurality of types of RF thresholds supported by the UE to one or more respective RF configurations for the UE; and determining the RF configuration for the UE corresponding to the first type of RF thresholds based at least in part on the lookup table.

Aspect 14: The method of any of aspects 1 through 13, further comprising: communicating one or more uplink messages, one or more sidelink messages, one or more downlink messages, or any combination thereof based at least in part on the RF configuration for the UE.

Aspect 15: The method of any of aspects 1 through 14, wherein the first type of RF thresholds indicates a signal quality for transmission at the UE, the second message is transmitted based at least in part on the signal quality for transmission.

Aspect 16: A method for wireless communications at a network entity, comprising: transmitting, for a UE, a first message that configures the UE with a first type of RF thresholds from a plurality of types of RF thresholds supported by the UE, the first type of RF thresholds comprising at least an in-band performance threshold and an out-of-band performance threshold; and receiving a second message that satisfies the in-band performance threshold and the out-of-band performance threshold based at least in part on an RF configuration for the UE corresponding to the first type of RF thresholds.

Aspect 17: The method of aspect 16, further comprising: determining the first type of RF thresholds for the UE based at least in part on a distribution of UEs within a cell associated with the network entity, a location of the UE within the cell, a cell load for the cell, a scheduling distribution for communications associated with the UEs within the cell, an application type for the UE, a power threshold associated with the UE, a subscription plan associated with the UE, or any combination thereof.

Aspect 18: The method of any of aspects 16 through 17, further comprising: receiving a third message reporting the plurality of types of RF thresholds supported by the UE, wherein the RF configuration for the UE is in accordance with the third message.

Aspect 19: The method of any of aspects 16 through 18, further comprising: receiving a fourth message reporting a capability of the UE to dynamically switch between the plurality of types of RF thresholds supported by the UE, wherein the first message is transmitted based at least in part on the capability of the UE.

Aspect 20: The method of any of aspects 16 through 19, further comprising: receiving a fifth message requesting for the UE to switch to the first type of RF thresholds, wherein the first message is transmitted based at least in part on the fifth message.

Aspect 21: The method of any of aspects 16 through 20, further comprising: transmitting, for a second UE different from the UE, a sixth message scheduling one or more communications for the second UE based at least in part on the RF configuration for the UE.

Aspect 22: The method of aspect 21, further comprising: determining a first BWP associated with the RF configuration for the UE; and scheduling the one or more communications for the second UE for a second BWP different from the first BWP based at least in part on the RF configuration for the UE.

Aspect 23: The method of any of aspects 21 through 22, further comprising: predicting interference associated with the second message based at least in part on the first type of RF thresholds configured for the UE; and scheduling the one or more communications for the second UE based at least in part on the predicted interference.

Aspect 24: The method of any of aspects 16 through 23, further comprising: transmitting, for a second UE different from the UE, a seventh message that configures the second UE with a second type of RF thresholds from a second plurality of types of RF thresholds supported by the second UE based at least in part on the first type of RF thresholds configured for the UE.

Aspect 25: The method of any of aspects 16 through 24, further comprising: transmitting, for a second UE different from the UE, an eight message that configures the second UE with an MCS value based at least in part on a predicted impact of the first type of RF thresholds configured for the UE on the second UE.

Aspect 26: The method of any of aspects 16 through 25, wherein the first message comprises an RRC message, a MAC-CE, a DCI message, or any combination thereof.

Aspect 27: The method of any of aspects 16 through 26, further comprising: communicating one or more uplink messages, one or more downlink messages, or any combination thereof based at least in part on the RF configuration for the UE.

Aspect 28: A UE for wireless communications, comprising one or more memories storing processor-executable code, and one or more processors coupled with the one or more memories and individually or collectively operable to execute the code to cause the UE to perform a method of any of aspects 1 through 15.

Aspect 29: A UE for wireless communications, comprising at least one means for performing a method of any of aspects 1 through 15.

Aspect 30: A non-transitory computer-readable medium storing code for wireless communications, the code comprising instructions executable by one or more processors to perform a method of any of aspects 1 through 15.

Aspect 31: A network entity for wireless communications, comprising one or more memories storing processor-executable code, and one or more processors coupled with the one or more memories and individually or collectively operable to execute the code to cause the network entity to perform a method of any of aspects 16 through 27.

Aspect 32: A network entity for wireless communications, comprising at least one means for performing a method of any of aspects 16 through 27.

Aspect 33: A non-transitory computer-readable medium storing code for wireless communications, the code comprising instructions executable by one or more processors to perform a method of any of aspects 16 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message that configures the UE with a first type of radio frequency thresholds from a plurality of types of radio frequency thresholds supported by the UE, the first type of radio frequency thresholds comprising at least an in-band performance threshold and an out-of-band performance threshold; and
transmit a second message that satisfies the in-band performance threshold and the out-of-band performance threshold based at least in part on a radio frequency configuration for the UE corresponding to the first type of radio frequency thresholds.

2. The UE of claim 1, wherein the one or more processors are individually or collectively further operable to execute the code to cause the UE to:
select the radio frequency configuration for the UE based at least in part on the first message.

3. The UE of claim 2, wherein, to select the radio frequency configuration for the UE, the one or more processors are individually or collectively operable to execute the code to cause the UE to:
set a power amplifier bias value, a power amplifier current value, a threshold transmit power level, or a combination thereof for the UE, wherein the second message is transmitted according to the power amplifier bias value, the power amplifier current value, the threshold transmit power level, or the combination thereof.

4. The UE of claim 1, wherein the one or more processors are individually or collectively further operable to execute the code to cause the UE to:
transmit a third message reporting the plurality of types of radio frequency thresholds supported by the UE, wherein the first message that configures the UE is in accordance with the third message.

5. The UE of claim 1, wherein the one or more processors are individually or collectively further operable to execute the code to cause the UE to:
transmit a fourth message reporting a capability of the UE to dynamically switch between the plurality of types of radio frequency thresholds supported by the UE, wherein the first message is received based at least in part on the capability of the UE.

6. The UE of claim 1, wherein the one or more processors are individually or collectively further operable to execute the code to cause the UE to:
transmit a fifth message requesting to switch to the first type of radio frequency thresholds based at least in part on a current battery power of the UE, an active radio configuration for the UE, or both, wherein the first message is received based at least in part on the fifth message.

7. The UE of claim 6, wherein the fifth message comprises a UE assistance information message.

8. The UE of claim 1, wherein the first message comprises a first radio resource control message, a first medium access control element, or a first combination thereof.

9. The UE of claim 8, wherein the one or more processors are individually or collectively further operable to execute the code to cause the UE to:
switch to the radio frequency configuration for the UE based at least in part on the first radio resource control message, the first medium access control element, or the first combination thereof;
receive a second radio resource control message, a second medium access control element, or a second combination thereof that configures the UE with a second type of radio frequency thresholds from the plurality of types of radio frequency thresholds supported by the UE; and
switch to a second radio frequency configuration for the UE corresponding to the second type of radio frequency thresholds based at least in part on the second radio resource control message, the second medium access control element, or the second combination thereof.

10. The UE of claim 1, wherein the first message comprises a downlink control information message.

11. The UE of claim 10, wherein the one or more processors are individually or collectively further operable to execute the code to cause the UE to:
switch from a first radio frequency configuration for the UE to the radio frequency configuration for the UE for a transmission opportunity associated with the second message based at least in part on the downlink control information message indicating the transmission opportunity; and
switch back to the first radio frequency configuration for the UE for a subsequent transmission opportunity.

12. The UE of claim 1, wherein the one or more processors are individually or collectively further operable to execute the code to cause the UE to:
communicate in accordance with a default type of radio frequency thresholds prior to receiving the first message that configures the UE with the first type of radio frequency thresholds.

13. The UE of claim 1, wherein the one or more processors are individually or collectively further operable to execute the code to cause the UE to:
store a lookup table that maps one or more types of radio frequency thresholds from the plurality of types of radio frequency thresholds supported by the UE to one or more respective radio frequency configurations for the UE; and
determine the radio frequency configuration for the UE corresponding to the first type of radio frequency thresholds based at least in part on the lookup table.

14. The UE of claim 1, wherein the one or more processors are individually or collectively further operable to execute the code to cause the UE to:
communicate one or more uplink messages, one or more sidelink messages, one or more downlink messages, or any combination thereof based at least in part on the radio frequency configuration for the UE.

15. The UE of claim 1, wherein the first type of radio frequency thresholds indicates a signal quality for transmission at the UE, wherein the second message is transmitted based at least in part on the signal quality for transmission.

16. A network entity, comprising:
one or more memories storing processor-executable code; and
one or more processors coupled with the one or more memories and individually or collectively operable to execute the code to cause the network entity to:
transmit, for a user equipment (UE), a first message that configures the UE with a first type of radio frequency thresholds from a plurality of types of radio frequency thresholds supported by the UE, the first type of radio frequency thresholds comprising at least an in-band performance threshold and an out-of-band performance threshold; and
receive a second message that satisfies the in-band performance threshold and the out-of-band performance threshold based at least in part on a radio frequency configuration for the UE corresponding to the first type of radio frequency thresholds.

17. The network entity of claim 16, wherein the one or more processors are individually or collectively further operable to execute the code to cause the network entity to:
determine the first type of radio frequency thresholds for the UE based at least in part on a distribution of UEs within a cell associated with the network entity, a location of the UE within the cell, a cell load for the cell, a scheduling distribution for communications associated with the UEs within the cell, an application type for the UE, a power threshold associated with the UE, a subscription plan associated with the UE, or any combination thereof.

18. The network entity of claim 16, wherein the one or more processors are individually or collectively further operable to execute the code to cause the network entity to:
receive a third message reporting the plurality of types of radio frequency thresholds supported by the UE, wherein the radio frequency configuration for the UE is in accordance with the third message.

19. The network entity of claim 16, wherein the one or more processors are individually or collectively further operable to execute the code to cause the network entity to:
receive a fourth message reporting a capability of the UE to dynamically switch between the plurality of types of radio frequency thresholds supported by the UE, wherein the first message is transmitted based at least in part on the capability of the UE.

20. The network entity of claim 16, wherein the one or more processors are individually or collectively further operable to execute the code to cause the network entity to:
receive a fifth message requesting for the UE to switch to the first type of radio frequency thresholds, wherein the first message is transmitted based at least in part on the fifth message.

21. The network entity of claim 16, wherein the one or more processors are individually or collectively further operable to execute the code to cause the network entity to:
transmit, for a second UE different from the UE, a sixth message scheduling one or more communications for the second UE based at least in part on the radio frequency configuration for the UE.

22. The network entity of claim 21, wherein the one or more processors are individually or collectively further operable to execute the code to cause the network entity to:
determine a first bandwidth part associated with the radio frequency configuration for the UE; and
schedule the one or more communications for the second UE for a second bandwidth part different from the first bandwidth part based at least in part on the radio frequency configuration for the UE.

23. The network entity of claim 21, wherein the one or more processors are individually or collectively further operable to execute the code to cause the network entity to:
predict interference associated with the second message based at least in part on the first type of radio frequency thresholds configured for the UE; and
schedule the one or more communications for the second UE based at least in part on the predicted interference.

24. The network entity of claim 16, wherein the one or more processors are individually or collectively further operable to execute the code to cause the network entity to:
transmit, for a second UE different from the UE, a seventh message that configures the second UE with a second type of radio frequency thresholds from a second plurality of types of radio frequency thresholds supported by the second UE based at least in part on the first type of radio frequency thresholds configured for the UE.

25. The network entity of claim 16, wherein the one or more processors are individually or collectively further operable to execute the code to cause the network entity to:
transmit, for a second UE different from the UE, an eight message that configures the second UE with a modulation and coding scheme value based at least in part on a predicted impact of the first type of radio frequency thresholds configured for the UE on the second UE.

26. The network entity of claim 16, wherein the first message comprises a radio resource control message, a medium access control element, a downlink control information message, or any combination thereof.

27. The network entity of claim 16, wherein the one or more processors are individually or collectively further operable to execute the code to cause the network entity to:
communicate one or more uplink messages, one or more downlink messages, or any combination thereof based at least in part on the radio frequency configuration for the UE.

28. A method for wireless communications at a user equipment (UE), comprising:
receiving a first message that configures the UE with a first type of radio frequency thresholds from a plurality of types of radio frequency thresholds supported by the UE, the first type of radio frequency thresholds comprising at least an in-band performance threshold and an out-of-band performance threshold; and
transmitting a second message that satisfies the in-band performance threshold and the out-of-band performance threshold based at least in part on a radio frequency configuration for the UE corresponding to the first type of radio frequency thresholds.

29. The method of claim 28, further comprising:
selecting the radio frequency configuration for the UE based at least in part on the first message.

30. A method for wireless communications at a network entity, comprising:
transmitting, for a user equipment (UE), a first message that configures the UE with a first type of radio frequency thresholds from a plurality of types of radio frequency thresholds supported by the UE, the first type of radio frequency thresholds comprising at least an in-band performance threshold and an out-of-band performance threshold; and
receiving a second message that satisfies the in-band performance threshold and the out-of-band performance threshold based at least in part on a radio frequency configuration for the UE corresponding to the first type of radio frequency thresholds.
